(19) United States
(12) Patent Application Publication
(10) Pub. No.: US 2024/0077869 A1
(43) Pub. Date: Mar. 7, 2024

(54) CONTROL APPARATUS, HAMILTONIAN CYCLE EXTENSION APPARATUS, THESE METHODS AND PROGRAMS

(71) Applicant: NIPPON TELEGRAPH AND TELEPHONE CORPORATION, Tokyo (JP)

(72) Inventor: Hiroshi KAWANO, Tokyo (JP)

(73) Assignee: NIPPON TELEGRAPH AND TELEPHONE CORPORATION, Tokyo (JP)

(21) Appl. No.: 18/272,264

(22) PCT Filed: Jan. 15, 2021
(86) PCT No.: PCT/JP2021/001191

§ 371 Date: Jul. 13, 2023

(51) Int. Cl. G05D 1/00

(52) U.S. Cl. CPC G05D 1/00

(57) ABSTRACT

An control device includes a first movement plan unit 1 that creates a first movement plan for moving each control object at an initial position to an intermediate position in the control object units, a first movement unit 2 that moves each control object at the initial position to the intermediate position in control object units according to the first movement plan, a second movement plan unit 3 that creates a second movement plan for moving each control object assumed to be at a target position to the intermediate position in the control object units, an intermediate position replacement unit 4 that moves each control object moved by the first movement unit to a movement destination of each control object determined by the second movement plan among the intermediate positions, and a second movement unit 5 that moves each control object at the intermediate position to the target position in the control object units according to a plan obtained by temporally reversing the second movement plan.

### TECHNICAL FIELD

The present invention relates to a technique for controlling actions of a plurality of control objects or a technique for expanding a Hamiltonian cycle.

### BACKGROUND ART

In recent years, active research is being conducted into efficiently controlling a large number of autonomous mobile robots. The content of this task is various, including monitoring locations which people cannot enter, transporting goods, and so on, but there is a need for technology that enables efficient rank formation through coordinated operations of a large number of robots, and research into this technology is actively being undertaken.

Especially, in a robot rank control under the assumption that the robots move as a whole as in an amoeba in a state where the robots are in contact with each other among the robot rank control, there are the advantage that the absolute position of each robot can be determined, and the advantage that additional equipment for position measurement is not required, and such research is being undertaken. For example, in a series of researches leading to the research shown in NPL 1, rank control for changing from a rank to another rank shown (for example, refer to NPL 1).

In this manner, to realize efficient rank formation by a large number of robots, it is important to plan the arrangement, operation order, and so on of each robot in advance. In such a plan, the presence of an obstacle and the shape of a route in an actual environment in which a plurality of robots operate must be considered sufficiently.

In the technique disclosed in the research shown in NPL 1, the rank deformation of the robot is handled by an expansion and contraction surface operation between a plurality of cubic robots (an operation of a certain robot moving while expanding and contracting in a state of contacting with other robots).

Here, it is assumed that each robot operates in contact with other robots, and each robot is in the same characteristic (homogeneous). In other words, the rank control is realized when the target position of each robot within a target form is not determined. In addition, a deformation of the robot structure based on a robot unit constituted by 8 mass robots is handled. The deformation requires a deformation time proportional to the square of the number of robots.

In NPL 2, the rank deformation of the robot due to a surface shear operation between a plurality of cubic robots (an operation of sliding a certain robot on a contact surface in a state of contacting with other robots) is handled. Also, the deformation of the robot structure based on the robot unit constituted by 8 mass robots is handled. Each robot unit is a different characteristic (heterogeneous). In other words, the rank control is realized when the target position of each robot unit within the target form is determined for each robot unit. The deformation requires a deformation time proportional to the number of robots. In NPL 2, robots in the same robot unit are handled as homogeneous, and the robots in the same robot unit cannot set the mutual positional relationship to positions designated before and after the rank deformation.

In NPL 3, the rank deformation of the robot due to the surface shear operation between a plurality of cubic robots (an operation of sliding a certain robot on a contact surface in a state of contacting with other robots) is handled. In this case, the robot unit of 8 mass is not used, and the deformation of the robot structure of full resolution is handled. Each robot is a different characteristic (heterogeneous). In other words, the rank control is realized when the target position of each robot within the target form is determined for each robot. The deformation requires a deformation time proportional to the number of robots.

In both of NPLs 1 and 2, a space other than a space occupied by the set of the initial position and the target position of the robot is not required in the deformation process, are applicable in a space where an obstacle is present, and the invention of NPL 3 requires a free space having no obstacle in the deformation process.

### CITATION LIST

### Non Patent Literature

[NPL 1] S. Vassilvitskii, M. Yim, J. Suh, “A Complete, Local and Parallel Reconfiguration Algorithm for Cube Style Modular Robots”, in Proc. 2002 IEEE Int. Conf. Robotics and Automation, pp. 117-122, Washington DC, May, 2002
[NPL 2] Kawano H., “Distributed Linear Heterogeneous Reconfiguration of Cubic Modular Robots via Simultaneous Tunneling and Permutation”, IEEE Transactions on Robotics, Vol. 36, Issue 1, pp. 62-77, February 2020
[NPL 3] Kawano, H., “Parallel Permutation for Linear Full Resolution Reconfiguration of Heterogeneous Sliding-only Cubic Modular Robots”, 2020 IEEE International Conference on Robotics and Automation, pp. 8281-8287, May 2020, Paris, France

### SUMMARY OF INVENTION

### Technical Problem

However, in a rank deformation in which the target position is determined for each control object (in other words, a rank control capable of the heterogeneous rank deformation in each control object) and movement is performed in the control object units, there is no control technique for performing high-speed rank deformation.

A first object of the present invention is to provide a control device, a method, and a program that perform a rank deformation at high speed in the rank deformation in which a target position is determined in each control object and movement is performed in the control object units.

In addition, in a conventional art, there has been no technique for expanding a Hamiltonian cycle forming an intermediate position, for example.

Then, a second object of the present invention is to provide a Hamiltonian cycle expansion device, a method, and a program for expanding a Hamiltonian cycle.

### Solution to Problem

In a control device according to an aspect of the present invention, a control object unit includes a first type control object unit and a second type control object unit, each of the first type control object unit and the second type control object unit is constituted by U (U is an integer of 4 or more) of control objects, an initial position and a target position are determined for each control object, a structure constituted by the control object located at the initial position and the target position is constituted by a combined control object unit constituted by 2 U control objects by combining the first type control object unit and the second type control object unit, a graph in which a control object unit in an intermediate position is defined as a node and a surface connecting two control object units in contact with each other is defined as an edge is defined as a Hamiltonian cycle, and there is a space in which another control object unit can pass through and the positions are replaced between control object units in a peripheral on the control object unit located in the intermediate position, the control device includes a first movement plan unit that creates a first movement plan for moving each control object at the initial position to an intermediate position in control object units, a first movement unit that moves each control object at the initial position to the intermediate position in the control object units according to the first movement plan, a second movement plan unit that creates a second movement plan for moving each control object assumed to be at the target position to the intermediate position in the control object units, an intermediate position replacement unit that moves each control object moved by the first movement unit to a movement destination of each control object determined by the second movement plan among the intermediate positions, and a second movement unit that moves each control object at the intermediate position to the target position in the control object units according to a plan obtained by temporally reversing the second movement plan.

A Hamiltonian cycle expansion device according to an aspect of the present invention includes a selection unit that selects two nodes a, b which are respectively located at positions in contact with two adjacent nodes k, k+1 on a Hamiltonian cycle and are not located on the Hamiltonian cycle, an addition unit that adds the selected two nodes a, b to the Hamiltonian cycle as new nodes and adds edges connecting the two nodes k, k+1 and the two nodes a, b to the Hamiltonian cycle as new edges, and a control unit that expands the Hamiltonian cycle by repeating the processing of the selection unit and the addition unit.

### Advantageous Effects of Invention

According to the present invention, in a rank deformation in which a target position is determined for each control object, and movement is performed in control object units, the rank deformation can be performed at high speed. Alternatively, according to the present invention, the Hamiltonian cycle can be expanded.

### BRIEF DESCRIPTION OF DRAWINGS

FIG. 1 is a diagram for explaining an example of robot movement.

FIG. 2 is a diagram for explaining examples of initial and target positions in control object units.

FIG. 3 is a diagram for explaining an example of a state of void movement.

FIG. 4 is a diagram for explaining an example of a control object unit.

FIG. 5 is a diagram for explaining an example of tunneling.

FIG. 6 is a diagram for explaining an example of generating an intermediate position M.

FIG. 7 is a diagram for explaining a deformation process of S→M.

FIG. 8 is a diagram for explaining the deformation process of S→M.

FIG. 9 is a diagram for explaining an example of tunneling.

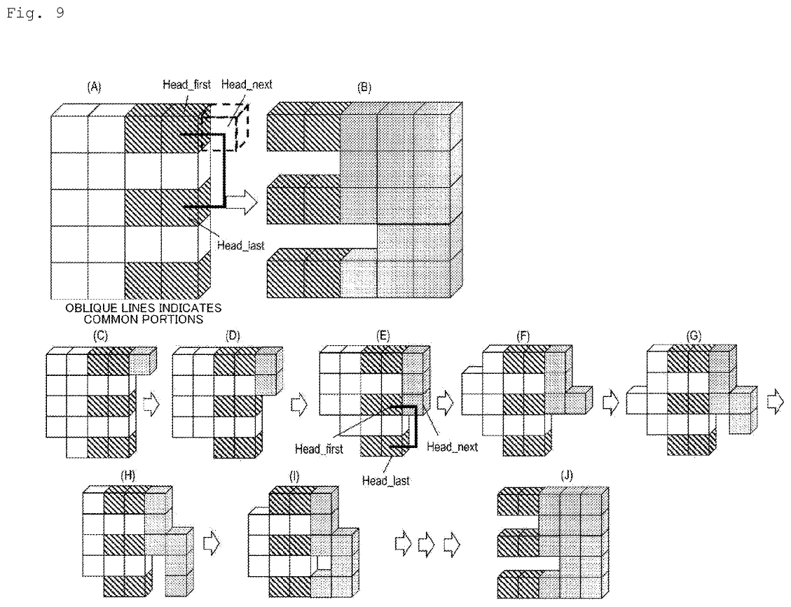

FIG. 10 is a diagram for explaining an example of movement of a control object unit.

FIG. 11 is a diagram for explaining an example of movement of the control object unit.

FIG. 12 is a diagram for explaining an example of movement of the control object unit.

FIG. 13 is a diagram for explaining an example of movement of the control object unit.

FIG. 14 is a diagram for explaining an example of movement of the control object unit.

FIG. 15 is a diagram for explaining an example of movement of the control object unit.

FIG. 16 is a diagram for explaining an example of movement of the control object unit.

FIG. 17 is a diagram for explaining an example of movement of the control object unit.

FIG. 18 is a diagram for explaining an example of movement of the control object unit.

FIG. 19 is a diagram for explaining an example of movement of the control object unit.

FIG. 20 is a diagram for explaining an example of movement of the control object unit.

FIG. 21 is a diagram for explaining an example of movement of the control object unit.

FIG. 22 is a diagram for explaining an example of movement of the control object unit.

FIG. 23 is a diagram for explaining an example of movement of the control object unit.

FIG. 24 is a diagram for explaining an example of movement of the control object unit.

FIG. 25 is a diagram for explaining an example of movement of the control object unit.

FIG. 26 is a diagram for explaining an example of movement of the control object unit.

FIG. 27 is a diagram for explaining an example of movement of the control object unit.

FIG. 28 is a diagram for explaining an example of movement of the control object unit.

FIG. 29 is a diagram for explaining an example of movement of the control object unit.

FIG. 30 is a diagram for explaining an example of movement of the control object unit.

FIG. 31 is a diagram for explaining an example of movement of the control object unit.

FIG. 32 is a diagram for explaining an example of movement of the control object unit.

FIG. 33 is a diagram for explaining an example of movement of the control object unit.

FIG. 34 is a diagram for explaining an example of movement of the control object unit.

FIG. 35 is a diagram for explaining an example of movement of the control object unit.

FIG. 36 is a diagram showing an example of a functional configuration of a control device.

FIG. 37 is a diagram showing an example of a processing procedure of a control method.

FIG. 38 is a diagram showing an example of a functional configuration of a Hamiltonian cycle expansion device.

FIG. 39 is a diagram showing an example of a processing procedure of a Hamiltonian cycle expansion method.

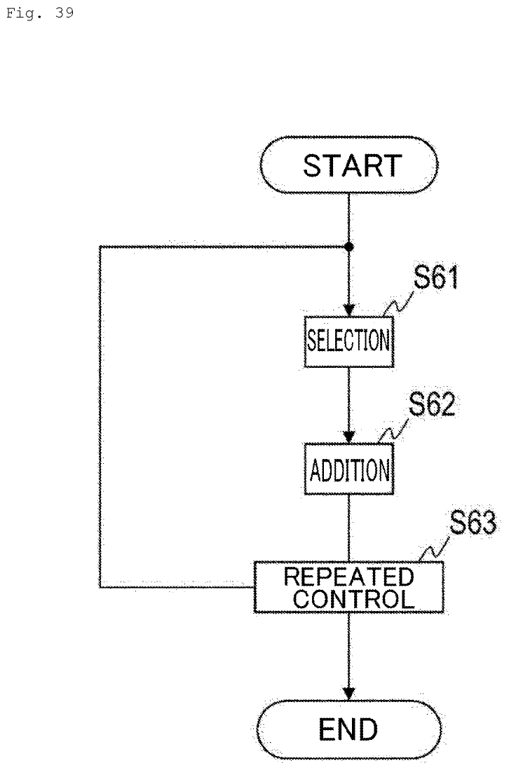

FIG. 40 is a diagram showing an example of a functional configuration of a computer.

### DESCRIPTION OF EMBODIMENTS

Hereinafter, embodiments of the present invention will be described. Note that in the figures used in the following description, constituent parts having identical functions and steps in which identical processing is performed have been allocated identical reference numerals, and duplicate description thereof has been omitted.

<Theoretical Background>

First, a theoretical background to a control device and method will be described. A case in which the control object serving as the action control subject is a robot will be described below as an example, but the control object is not limited to a robot and may be any object that can be subjected to control.

[Problem Setting]

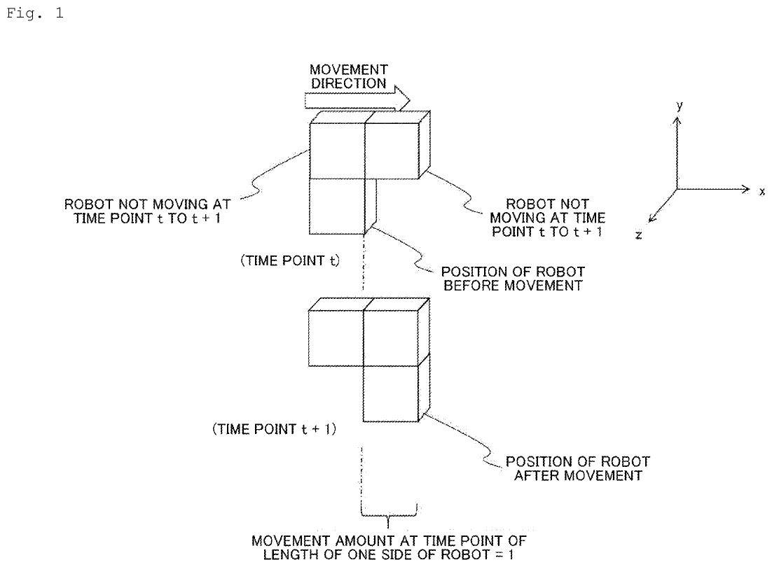

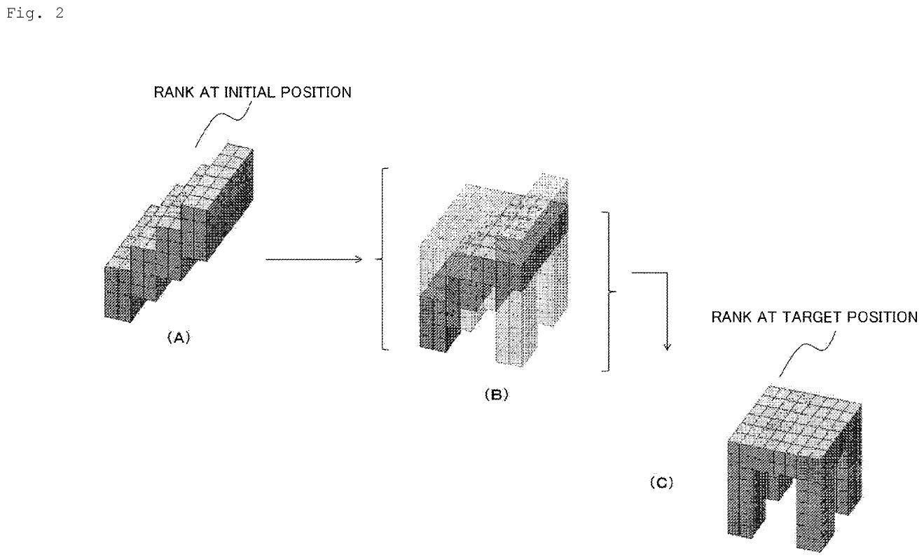

In a task in which a large number of control objects cooperatively perform a rank deformation from rank formation state at initial positions to target positions by moving while remaining a state in which each control object is in contact with each other, a use of cubic control object capable of moving by sliding over mutual contact surfaces, as exemplified in FIG. 1, for example, is envisaged. As shown in FIG. 2, this task is realized by moving a plurality of control objects from initial positions to target positions in a room segmented by a wall (where, a wall is omitted in figures).

As shown in FIG. 1, for example, the control object is assumed to move while maintaining a state in which another control object exists in one of 6 mass upward, downward, leftward, rightward, frontward, and rearward of the control object (referred to “upward, downward, leftward, rightward, frontward, and rearward direction” below). This method has an advantage in that by moving one control object by a distance corresponding to the size of a single control object, the movement amount of a single action can be measured accurately.

Further, by measuring relative positions of adjacent control objects sharing a single surface, the position of each control object from among all of the control objects in a control object group can easily be ascertained. As a result, a problem in which the rank collapses due to an error in the movement amount of the control objects is unlikely to occur.

Furthermore, a plurality of control objects can be moved simultaneously as if the plurality of control objects was connected. Note that the control object is assumed to be capable of ascertaining whether or not another control object exists in a position adjacent thereto and whether or not the control object itself is in the target position.

The control object to be subjected to the task is p pieces (p≥32=8×4), and each control object is made movable in the X-Y-Z axis direction in the three-dimensional space while sharing one or more surfaces with the adjacent control object. Each cube in FIG. 1 shows the position of each control object. Only one control object can exist in each cube. When there is an obstacle or another control object in the moving direction, each control object is assumed to be stationary. Note that a cubic space in which the control object can exist is also referred to as a mass or a grid. In FIG. 2, dark gray mass indicates the positions where the control object is present. The positions where the control objects exist in FIG. 2A indicate the set of initial positions of the control objects, and the positions where the control objects exist in FIG. 2C indicate the set of target positions of the control objects. As shown in FIG. 2B, the set of target positions and the set of initial positions are in contact or have overlapping portions (common portions). An area represented by a set of target positions is also referred to as a target rank area. In other words, each initial position and each target position is adjacent to another initial position or target position in at least one direction among the upward, downward, leftward, rightward, frontward, and rearward directions, and the shapes of the rank formation in the initial positions and target positions of the control object are respectively arbitrary block shapes.

[Coordinate Setting of Control Object]

When the position of respective control objects i (i represents a control object number, i=0, 1, 2, 3, . . . , p−1) is (Xr[i], Yr[i], Zr[i]), the initial position is (Xr0[i], Yr0[i], Zr0[i]), and the target position is (Xre[i], Yre[i], Zre[i]), the problem is defined as obtaining an action plan for moving the control object arranged at the initial position to the target position. A set of initial positions of the control object is defined as s, and a set of target positions (Xre[i], Yre[i], Zre[i]) is defined as g.

[Definition of Task Space]

When i is defined as the control object number, each state of the control object i (position and action of the control object) are expressed by discrete values. When a room is represented by a three-dimensional space constituted by X, Y and Z orthogonal coordinate systems, each position is expressed by a value obtained by discretely expressing each of X-axis, Y-axis, and Z-axis. That is, the room (a three-dimensional space) is divided by the grid, and each grid corresponds to each position. In addition, in each grid, presence or absence of an obstacle is set in advance.

[Definition of Control Object Operation]

Further, the action subject becomes each control object arranged in the room. The action a of the control object i (i is the control object number) takes any one of seven kinds of actions remaining stationary, moving by 1 grid in any direction of upward, downward, leftward, rightward, frontward, and rearward. For example, a∈{0, 1, 2, 3, 4, 5, 6} is established.
0: remaining stationary
1: moving by one grid within the three-dimensional space in a direction in which the X coordinate value increases
2: moving by one grid within the three-dimensional space in a direction in which the Y coordinate value increases
3: moving by one grid within the three-dimensional space in a direction in which the X coordinate value decreases
4: moving by one grid within the three-dimensional space in a direction in which the Y coordinate value decreases
5: moving by one grid within the three-dimensional space in a direction in which the Z coordinate value increases
6: moving by one grid within the three-dimensional space in a direction in which the Z coordinate value decreases are defined.

[Problem in Search Calculation]

The state space in this type of task environment includes a number of states corresponding to the number of control objects x three-dimension numbers, and the number of selectable actions corresponds to the number of control object actions (=7) to the power of the number of control objects. For example, when the number of control objects is 50 and the number of grids in the upward, downward, leftward, rightward, frontward, and rearward direction the room is 20 each, the number of states is 20 to the power of 150, and therefore a massive amount of resources is required for search calculations. Moreover, each time the number of control object increases by 1, the number of states increases 8000 times. As described in the [Problem Setting] section of the present embodiment, even after adopting the constraint condition that the control objects contact each other, since the search calculation needs to be performed in consideration of mutual movement of the control objects, reducing the basic calculation amount is difficult and remains a significant problem in cases where a plurality of control objects are used.

[Features in References 1 and 2]

In the heterogeneous rank control in reference 1, a concept of void control is introduced as one of the measures for solving the above-mentioned problem of the calculation load. In addition, in order to overcome the problem of rank deformation as described in the “Problem Setting”, a concept of 8 mass control objects is also introduced.

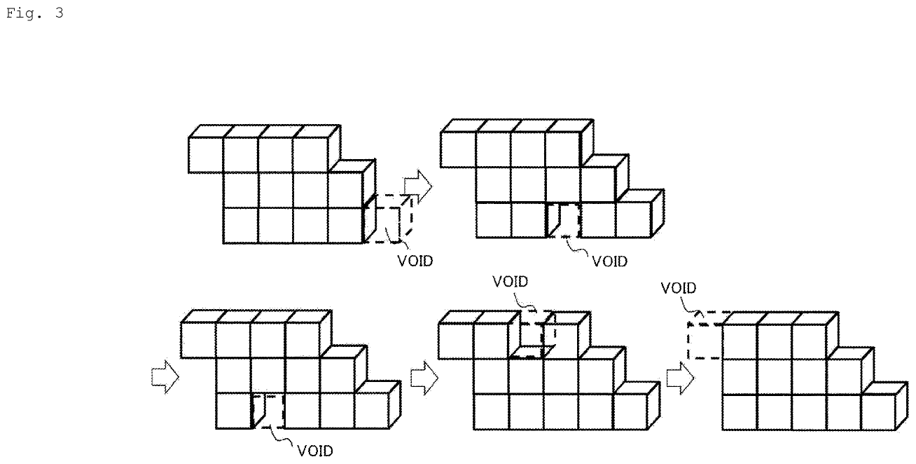

First, a void control will be described. The void described here is a gap, as exemplified in FIG. 3, formed at a vacant position after a certain control object has moved to another position. In other words, the void is a virtual presence that moves in a direction opposite to a direction in which the control object moves. In such a rank formation problem of the group control object, since attention is paid to the operations of a plurality of control objects, the search calculation amount is exploded, however, when attention is paid to the movement of the void by changing a viewpoint, the problem of the operation plan of a large number of control objects can be considered as the operation plan of a single void, and it is suitable for reducing the search calculation load. However, each control object belonging to the control object unit during the deformation operation becomes scattered and is divided into different control object units, and the load of the subsequent control object replacement operation is increased, and a space other than the set of the initial position and the target position is not required for deformation, but a delay of deformation that a time required for deformation is proportional to a square of the control object number is a problem. The main cause is a long time required for the position replacement operation of each control object. When performing the replacement operation, it is difficult to secure a space necessary for the replacement operation in a robot structure in which control objects are densely assembled and therefore, it is difficult to speed up the replacement process by performing the replacement operation of a plurality of sets of control objects in parallel.

In reference 2, deformation by void control under homogeneous conditions is realized in consideration of the fact that there is a plurality of common portions of the set of the initial position and the target position. Similarly, it is difficult to secure a space necessary for simultaneous movement of a plurality of voids in a robot structure in which the control objects are densely assembled, and therefore it is difficult to speed up the deformation process by moving the plurality of control objects in parallel.
[Reference 1] Kawano, H., “Tunneling-Based Self-Reconfiguration of Heterogeneous Sliding Cube-Shaped Modular Robots in Environments with Obstacles”, 2017 IEEE International Conference on Robotics and Automation, pp. 825-832, May 2017, Singapore
[Reference 2] H. Kawano, “Distributed Tunneling Reconfiguration of Sliding Cubic Modular Robots in Severe Space Requirements”, in Proc. 14th Int. Symposium on Distributed Autonomous Robotic Systems, paper No. 1, Boulder, CO, October, 2018

[Introduction of 4 Mass Control Object Unit]

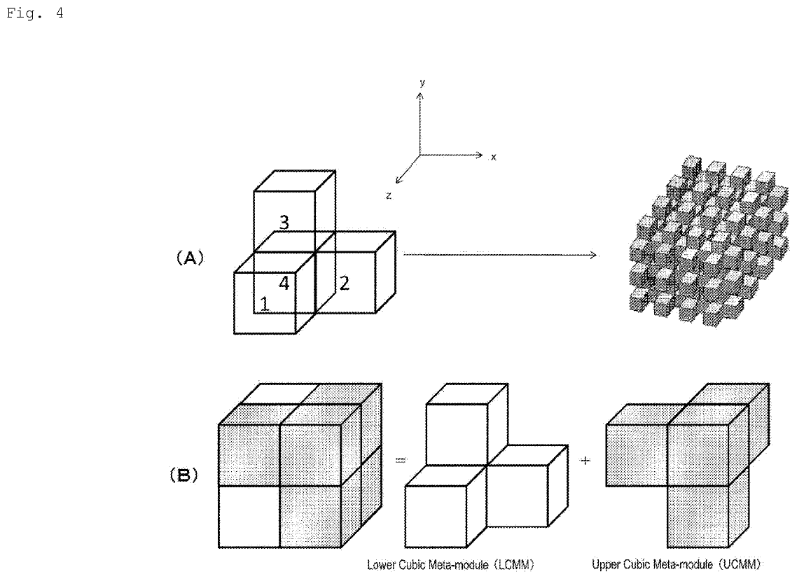

Therefore, as shown in FIG. 4A, four adjacent control objects are defined as one unit (the control object unit) and the control object moves while maintaining the control object unit. In other words, one control object unit is configured for each of the four control objects, and the four control objects constituting one control object unit move while maintaining a state adjacent to the other control objects constituting one control object unit in three directions. The group of the control object units is controlled so as to mutually share one surface for each control object unit and move while contacting with each other. It is assumed that four control objects belonging to the same control object unit are not the same but heterogeneous, and each control object has a unique target position and moves between different control object units before and after the rank deformation.

The reason why the four control objects are moved as one unit is that the control objects belonging to the other control object unit can pass through the four gap spaces inside each control object unit, and thereby the control objects belonging to the different control object units can easily come and go. Further, it is easy to maintain connectivity when a control object belonging to another control object unit passes through four gap spaces inside each control object unit. That is, this is because the calculation load for considering the connection between the control objects is reduced in the determination of the operation of each control object which must be considered to maintain the rank formation.

Here, the control object unit formed by the four control objects is defined as one mass unit (in the present embodiment, this unit called “mass unit” or “position unit” below), and one mass unit is set in one state to form a state space. When the position of the control object unit is represented by (Xr_u[j], Yr_u[j], Zr_u[j]) (j=0, 1, 2, j_max−1), the control object in the control object unit j is represented by i1, i2, i3, and i4,

Xr[i1]=2×Xr_u[j]

Yr[i1]=2×Yr_u[j]+1

Zr[i1]=2×Zr_u[j]

Xr[i2]=2×Xr_u[j]+1

Yr[i2]=2×Yr_u[j]

Zr[i2]=2×Zr_u[j]

Xr[i3]=2×Xr_u[j]

Yr[i3]=2×Yr_u[j]

Zr[i3]=2×Zr_u[j]+1

Xr[i4]=2×Xr_u[j]

Yr[i4]=2×Yr_u[j]

Zr[i4]=2×Zr_u[j]

Note that a variable representing a control object unit j to which each control object i belongs is defined as Rr[i]=j. In addition, a variable indicating which position of i1, i2, i3, and i4 the control object is located is defined as Ir[i]=(1, 2, 3, 4). The initial position of each control object unit is defined as (Xr_u0[j], Yr_u0[j], Zr_u0[j]), and the target position is defined as (Xr ue[j], Yr ue[j], Zr ue[j]). Hereinafter, the total number of the control objects p is set to a multiple of 4.

In addition, as shown in FIG. 4B, by combining two control object units, it is also possible to constitute a control object unit of 8 mass, and the rank control of the control object group constituted by control object units of 8 mass is also possible by controlling the control object unit of 4 mass. A combination of these two control object units may be referred to as a combined control object unit.

In addition, the present invention is not limited to the example shown in FIG. 4, and the control object unit may be constructed so as to satisfy the following conditions. That is, the control object unit includes that (1) the control object unit is a partial structure in a cubic space (hereinafter, this space is defined as a meta-module) having a length M (M≥2, where the length of one control object is defined as length 1) in each axial direction in the three-dimensional orthogonal coordinate system (In other words, the control object unit occupies a part of the meta-module), (2) the number of control objects included in the control object unit in the meta-module is equal to the number of parts other than the control object unit in the meta-module (that is, the number of voids), and (3) the control object unit includes a structure in which M control objects are adjacent in each axial direction. For example, the control object unit exemplified in FIG. 4 includes that (1) the control object unit is a partial structure of a meta-module constituted by a cube of 8 mass in total with the length M=2 in the respective axial directions, (2) the number of control objects in the control object unit is 4, the number of voids in the meta-module is 4, and these are equal, and (3) the structure in which two control objects are adjacent in each axial direction is included.

In the following description, a case where a structure constituted by four control objects shown in FIG. 4 is defined as a control object unit is described as an example of the control object unit, but for example, if the control object unit is constructed so that the above-mentioned conditions (1) to (3) are satisfied in a meta module having a size of M³, the same effect can be obtained.

[Heterogeneous Rank Control]

A heterogeneous control object rank control method in which a structure constituted by each control object i constituting an 8 mass control object unit is deformed from a state in which each control object is present at an initial position (Xr0[i], Yr0[i], Zr0[i]) in a set S of initial positions to a state in which each control object is present at a target position (Xre[i], Yre[i], Zre[i]) in a set G of target positions will be described below.

It is assumed that the sets S and G are constituted by 8 mass control object units formed by combining two 4 mass control object units. The number j_max of the 4 mass control object unit is even, and a relation j1+j_max/2=j2 is established between two 4 mass control object units j1 and j2 which constitutes one 8 mass control object unit (when j_max=8 is established, 0, 1, 2 and 3 are set to j1, 4, 5, 6 and 7 are set to j2, sets of (j1, j2)=(0, 4) (1, 5) (2, 6) (3, 7) constitute 8 mass unit). j2 is a 4 mass control object unit represented by dots in FIG. 4B. The name of j1 is defined as LCMM, and the name of j2 is defined as UCMM. In some cases, j1 is referred to as a second type control object unit, and j2 is referred to as a first type control object unit.

In this way, the control object unit includes a first type control object unit and a second type control object unit, each of the first type control object unit and the second type control object unit is constituted by U control objects (U is an integer of 4 or more), an initial position and a target position are determined in each control object, a structure constituted by control objects which are located at the initial position and the target position is constituted by a combined control object unit which is constituted by 2 U control objects by combining the first type control object unit and the second type control object unit.

In the process of deformation, an intermediate position for replacing the position of each robot is defined as M.

Here, the deformation of the robot from S to G is divided into the following three processes.
(1) Homogeneous deformation process from S to M
(2) Process of replacing the position of each control object in M
(3) Homogeneous deformation process from M to G

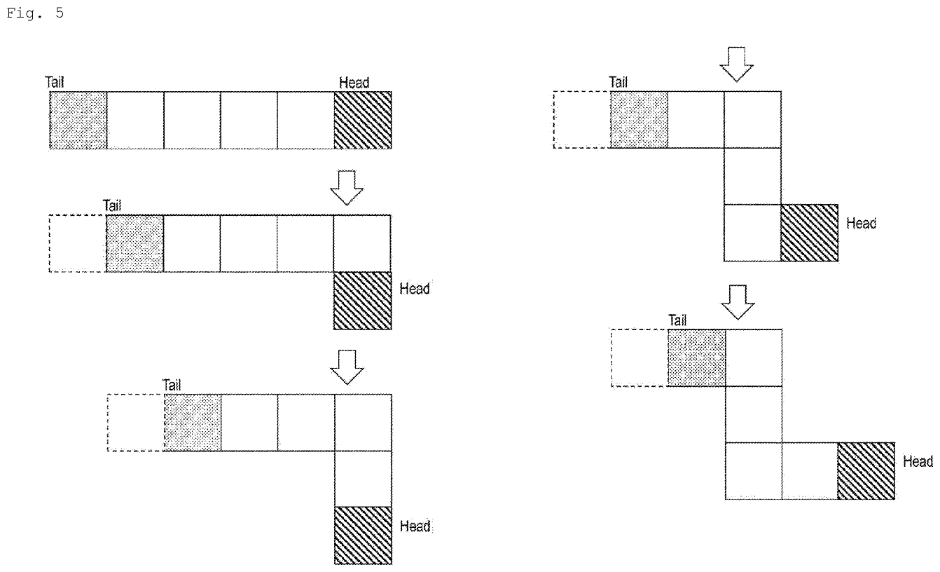

As shown in FIG. 5, in the process of deformation (1) and (3), a method called a tunneling is adopted. In the operation shown in FIG. 5, a series of control object units connecting the head control object unit Head and the tail control object unit Tail operate in a manner to follow the operation of the head control object unit Head in a so-called snake manner.

Note that the tunneling operation is similar to the control object unit performing another tunneling, for example, a control object structure using the control object unit of 2×2×2 in which an expansion contraction control object unit as shown in NPL 1 is used, and the method of selecting Head and Tail of the tunneling shown in the present invention can be applied in the same manner. Even in an environment where there is an obstacle in the rank deformation using the tunneling, there is an advantage that the rank deformation operation can be executed without using any position other than the set of initial positions and the set of target positions.

A robot intermediate position M where the process of replacing the control object in the process (2) is performed is constituted by 4 mass control object unit (attention to the point that it is different from S, G constituted by 8 mass units). By adopting a robot structure by the control object unit of 4 mass, a space of 4 mass for allowing the control object belonging to the other control object unit to pass through in each control object unit and allowing each control object to replace the position can be secured. The respective control object units in M hold such a space, so that the replacing operation of the control object can be performed simultaneously in parallel in the respective control object units, and the replacing operation can be speeded up.

As a condition related to the other M form, in a graph which is made when each control object unit in M is defined as a node (vertex) and two faces connecting two control object units in contact with each other are defined as an edge (branch), the graph must have a Hamiltonian cycle pH. This is because a plurality of control objects moving simultaneously in parallel to the position of the control object of the replacement destination for the replacement operation can reach the position of the respective replacement destination while avoiding collision with each other by following the common cycle pH. In this method, although it is difficult to individually optimize the routes to be traced by the respective control objects, it is possible to easily increase the number of control objects to be simultaneously replaced to the number close to the total number of control objects while giving the routes of a length having no practical problem to the respective control objects. As another approach, there is an approach of optimizing and calculating a route for each control object unit which moves simultaneously by route search while taking collision avoidance into consideration without using the Hamiltonian cycle pH, but when the number of control object units which are simultaneously replaced is increased to the limit as in the present invention, since the space available for securing the moving path of each moving control object is small, it is still difficult to realize a method for providing a solution with satisfactory high speed to the shape of an arbitrary robot structure by a route search based approach (a limiting solution is reported only for a rectangular parallelepiped robot structure). Therefore, the approach using the Hamiltonian cycle pH is advantageous in terms of realization.

Under the conditions related to the form of M described above, since the deformation processes of (1) and (3) are deformation processes between S and G constituted by the 8 mass control object unit and M constituted by the 4 mass control object, the structure made in the 8 mass control object unit is deformed with tunneling while being developed into a structure made in the 4 mass control object unit. As a matter of course, as the positional relationship between S and G, S∩G (the common part of S and G) may not be an O set, so that the common part of S and G S and G may not be an O set, it is also necessary to consider that there is a plurality of control objects included in S∩M (the common part of S and M) and M∩G (the common part of M and G) as the consequence in the same manner as in the case of the above-mentioned [reference 2]. The problem “low speed property resulting from difficulty in simultaneous movement of the control object by a dense robot structure” in [reference 1] and [reference 2] can be solved by adopting a structure M having a large number of gaps using the 4 mass control object unit in the present invention.

[Determination of Intermediate Position M]

As a condition related to the form of M, in a graph made when each control object unit in M is defined as a node (vertex) and two faces connecting two control object units in contact with each other are defined as an edge (branch), the graph must have the Hamiltonian cycle pH (here, it is called that “M is a Hamiltonian graph shape”.), however, in the present state of graph theoretical research, since a method for generally determining whether or not an arbitrary graph has a Hamiltonian cycle when the graph is given is not established, for example, whether or not S+G is the Hamiltonian graph shape cannot be easily determined. Therefore, it is considered that a Hamilton graph satisfying the geometric conditions to be taken by M is generated from scratch.

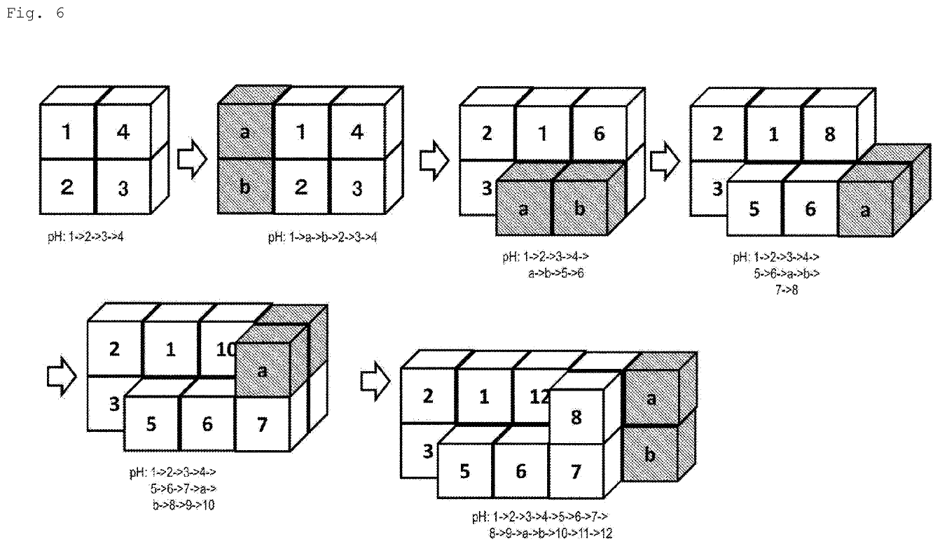

This technique will be briefly described. First, as a robot structure of a small Hamilton graph shape, a structure M₀ in which four control object units are arranged in a square shape is considered. M₀ clearly has the Hamiltonian cycle around four sides of the square as shown in FIG. 6. Here, two adjacent vertexes on the Hamiltonian cycle (for example, two adjacent control object units 1 and 2) are selected, two control objects a, b at positions in contact with the two control object units and at positions not overlapping with the control object in M₀ are added to M₀, and the structure in which edges respectively connecting control object unit 1 and a, a and b, and b and 2 are added is defined as M₁. Then, M₁ is a Hamiltonian graph-shaped structure having Hamiltonian cycle 1→a→b→2→3→4→1. By repeating the addition of such two control objects to M_{L} (L=0, 1, 2, 3, . . . ), M_{L} is grown, when M_{(jmax-4)/2} is finally generated, the number of control object units included in M_{(jmax-4)/2} becomes jmax, and M_{(jmax-4)/2} satisfies a condition required as M. In this case, by setting M₀ and adding two control objects of repetition aster setting to M_{L} in consideration of the position of an obstacle in the space where the robot deforms and the shapes of S and G, the shape of M can be determined in consideration of various geometric conditions of the space where the robot deforms. For example, M can be determined by the following processing.

[M_Decision]

(1) M₀ to be settled within S+G is selected.

(2) The process of from (3) to (4) is repeated.

(3) The control object units included in M_{L} are numbered 0, 1, 2, 3, . . . (4−1)+L×2 in the order of the Hamiltonian cycle in M_{L}.

(4) Two control object units having adjacent numbers (k-th, k+1-th, when k=(4−1)+L×2 is established, (4−1)+L×2-th and 0-th) are selected in ascending order, and when there are two new control object unit positions which are in contact with both of the two control object units, are in S+G and are not in M_{L} every selection, the two new control object unit positions (defined as a, b) are added to the M_{L}, and the Hamiltonian cycle of M_{L}+₁ are set to 0, 1, . . . , k, a, b, k+1, . . . , (4−1)+L×2. When the control object unit position included in M_{L}+1 does not become jmax, the process returns to (3). When the control object unit position included in M_{L}+1 becomes jmax, the process is terminated. When there is no control object position which is within the additional S+G and not within the M_{L} for all the adjacent control object sets in the Hamiltonian cycle in the M_{L}, the process proceeds to (5).

(5) The process of from (6) to (7) is repeated.

(6) The control object units included in M_{L} are numbered 0, 1, 2, 3, . . . (4−1)+L×2 in the order of the Hamiltonian cycle in M_{L}. k=0 is set.

(7) Two control object units having adjacent numbers (k-th, k+1-th, when k=(4−1)+L×2 is established, (4−1)+L×2-th and 0-th) are selected in ascending order, and when there are two new control object unit positions which are in contact with both of the two control object units and in which at least one of both is in S+G and both are not in M_{L}, the two new control object unit positions (defined as a, b) are added to the M_{L}, and the Hamiltonian cycle of M_{L}+1 are set to 0, 1, . . . , k, a, b, k+1, . . . , (4−1)+L×2. When the control object unit position included in M_{L}+₁ does not become jmax, the process returns to (6). When the control object unit position included in M_{L}+₁ become jmax, the process is terminated. When there is no additional control object position for all the adjacent control object sets in the Hamiltonian cycle in the M_{L}, the process proceeds to (8).

(8) The process of from (9) to (10) is repeated.

(9) The control object unit included in M_{L} is numbered 0, 1, 2, 3, . . . , (4−1)+L×2 in the order of the Hamiltonian cycle in M_{L}. k=0 is set.

(10) When two control object units having adjacent numbers (k-th, k+1-th, when k=(4-1)+L×2 is established, (4-1)+L×2-th and 0-th) are selected in ascending order and there are two new control object unit positions which are in contact with both of these two control object units, are not in M_{L} and does not overlap the obstacle position, the two new control object unit positions (defined as a, b) are added to the M_{L}, and the Hamiltonian cycle of M_{L}+₁ are set to 0, 1, . . . , k, a, b, k+1, . . . , (4-1)+L×2. When the control object unit position included in M_{L}+1 does not become jmax, the process returns to (6). When the control object unit position included in M_{L}+1 becomes jmax, the process is terminated. When there is no additional control object position for all the adjacent control object sets in the Hamiltonian cycle in the M_{L}, the process proceeds to (11).

(11) Another M₀ than the one selected so far is selected again within S+G. When it is not found in S+G, M₀ in a position where a part is in S+G and does not overlap an obstacle is selected and returned to (2).

Each vertex (control object unit) position of the Hamiltonian cycle in M selected by [M_Decision] is defined as (Hamilton_X[k], Hamilton_Y[k], Hamilton_Z[k]) (k=0, 1, 2, . . . jmax−1).

[Deformation Process of S→M]

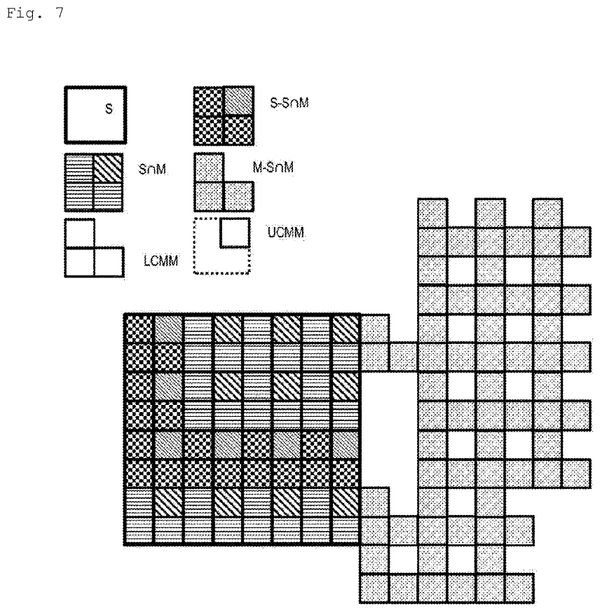

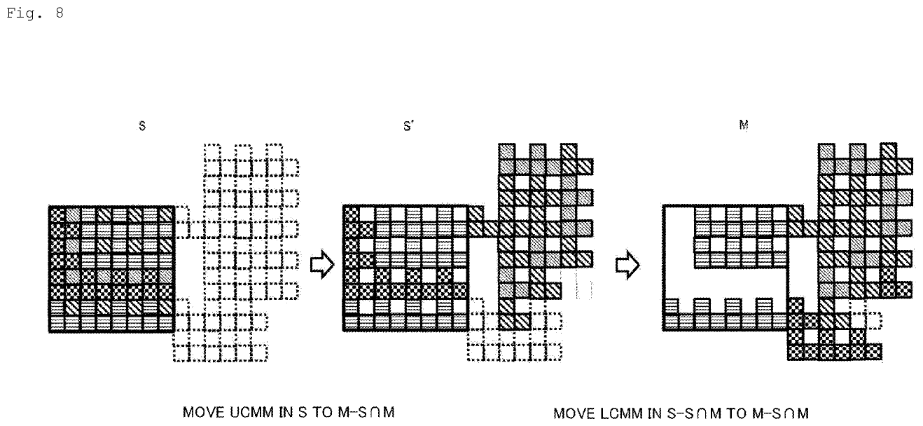

This deformation process is roughly divided into two processes (FIGS. 7 and 8).

In FIGS. 7 and 8, the initial position S is indicated by a bold line, the LCMM at the position of S∩M is indicated by a mass with a horizontal line, the UCMM at the position of S∩M is indicated by a mass with a thick diagonal line, the LCMM at the position of S-S∩M is indicated by a mass with a checkered pattern, the UCMM at the position of S-S∩M is indicated by a mass of a thin diagonal line, and the control object unit at the position of M-S∩M is indicated by a mass of a dot. In addition, among four masses indicating the position of the combined control object unit, three masses of the upper left, lower left and lower right indicate LCMM, one upper right mass represents UCMM.

(1) All the UCMMs in S are moved into M-S by the tunneling deformation to be an LCMM in M-S. More specifically, each first type control object unit at the initial position S is moved to M-S∩M by, for example, the tunneling deformation. In the selection of Head and Tail in the case of the tunneling, it is not necessary to consider the existence of the common part of S and M.

(2) The robot structure by the 4 mass control object unit produced in the process (1) is represented by S′, and the LCMM in S′ is moved by the tunneling deformation to perform a deformation from S′ to M. More specifically, each second control object unit in S-S∩M in S′ is moved to M-S∩M by the tunneling deformation. The method of selecting Head and Tail in the case of the tunneling is in the same way as [reference 2].

As described above, in the present process, the case where S′∩M is not null set and divided into a plurality of non-connected regions must be considered as in [reference 2], in the process (1), only the UCMM is moved, and the LCMM is not moved at all. For this reason, although S′∩M is null set or not, the connection between the LCMM control objects in S is not lost during the deformation process (the reason is that the non-moving LCMM holds the connection). Therefore, the process (1) does not require any special consideration such as that handled in [reference 2], and the UCMM may be moved into the M-S′ by the tunneling deformation method (close to NPL 1) in which the UCMM in the S located close to the M-S′ is selected preferentially as the tunneling Head. However, in the process (2), the situation is different, and as the LCMM in the S′ moves into the M, the control object in the S′ is lost, since there is a risk of losing the connection between the S′∩M divided into a plurality of non-connected regions, a technique, for example [reference 2] in which the risk is sufficiently considered, must be used. NPL 1 can be used only when the control object unit included in S′∩M is only one, and does not correspond to the general conditions of S′∩M.

For the tunneling technique of [reference 2], the method of selecting the head control object unit Head and tail control object unit Tail is easily reviewed. First, it is assumed that the common portion C of the set S′ and the set M is divided into Ncommon portions, and each part is defined as C[1], C[2], C[3], . . . , C[Ncommon]. The position of the common portion may be referred to as a common position.

First, attention should be paid to the selection of the head control object unit Head in order to prevent any of these Ncommon from being disconnected from the control object structure from the entire control object structure during the deforming operation. For example, assuming that the control object unit in S′ is gradually moved into M, the number of control object units remaining in S′ is reduced by that amount. If attention is neglected in this process, there may occur a situation in which the control object which can be used to prevent the common portion S′∩M from being disconnected from the control object structure does not exist in the S′ and M as well. For example, in NPL 1, a Tail at a position farthest from the position of Head (a position having a large Manhattan distance) is selected from the inside of the S′, however, if Tail is selected from the position within the S′∩M at that time, the control object unit once entering the M may be also moved as Tail, If the user does not care this, the loop of the infinite Head and Tail selection is entered. Further, by removing the control object unit in the M once buried, there is a possibility that a non-connection which is not assumed in NPL 1 occurs. As a method for avoiding them, one of C[l] is selected before the start of deformation, and all the positions in the selected C[l] are registered in the virtual common unit Up. Then, the Head is selected from the Up and the Tail is selected from the outside of the Up in the S′. Every time the tunneling is performed by one step, the position in the newly filled M′ is added to the Up. This process is repeated and when the Up is newly brought into contact with the control object of C[l] which is not registered yet in the Up in the process of enlarging and growing the Up, the control object position brought into contact with the Up in the S′∩M is added to the Up. By continuing this process, it is possible to create the same situation as the situation where the S′∩M virtually assumed in NPL 1 contains only one control object, and to prevent the occurrence of deadlock and non-connection during the deformation process.

The detail for the deformation process S→M is as follows.

[Deformation Process of S→M]

(1) The virtual robot executes [S→S′_UCMM_Navigation].

(2) The virtual robot executes [S′→M_LCMM_Navigation].

(3) [Linearization_S_M] is executed.

[S→S′_UCMM_Navigation] (Process (1))

(1) One position of the control object in contact with a position in M which is not buried in the control object is selected from the control objects in M or S, and is defined as E. If there is no such E, the process is ended.

(2) If there is a UCMM in E, the UCMM is moved to a gap position in M in contact with E, and defined as the LCMM in M.

(3) The UCMM in S at the Manhattan distance closest to E is moved to the position E. The moving route is a route in which the Manhattan distance from E is reduced by one for each moving step.

(4) The UCMM which has reached the position E is moved to the target position D with defining a position which is not yet buried in the M and has the closest distance from the position E in the Manhattan distance in the M as the target position D. A route tracing each position is generated so as to reduce the Manhattan distance one by one from D to E, and the UCMM is moved to D in the form of reverse-tracing the route from E to D. After the UCMM is moved to D, when “a gap in M which enters M-S via E as an inlet and reaches by tracing the control object unit already moved in M” still remains, the process returns to (3). If not, the process returns to (1).

[S′→M_LCMM_Navigation] (Process (2)

(1) all the positions in C[0] (one of S′∩M divided into a plurality of non-connected areas) are registered in the Up.

One position of the control object in contact with a position in M which is not buried in the control object yet is selected from the control objects in the Up, and defined as E. If there is no such E, the process is terminated.

(2) The LCMM in the S′ outside the Up at the most distant Manhattan distance from E is selected as Tail and moved to the position E. The moving route is a route in which the Manhattan distance from E is reduced by one for each moving step.

(3) The LCMM has reached the position E is moved to the target position D with defining a position which is not yet buried in the M and is closest in the Manhattan distance in the M from E as the target position D. A route tracing each position is generated so as to reduce the Manhattan distance one by one from D to E, and the LCMM is moved to D in the form of reverse-tracing the route from E to D. After the LCMM is moved to D, the position of D is registered in the Up, and when the LCMM is newly brought into contact with the control object in the S′∩M which is not yet registered in the Up, the position of the control object coming in contact with the Up in the S′∩M at the present time is added to the Up. Thereafter, if “a gap in M to be reached by tracing the control object unit which enters the M-S′ via E as an inlet and has been moved into the M” still remains, the process returns to (2). If not, the process returns to (1).

In the deformation process calculated by [S→S′_UCMM_Navigation], [S′→M_LCMM_Navigation], a system is adopted in which the control object unit to be moved starts moving one by one, reaches a target position and terminates the movement, and the movement of the control object unit is not performed in parallel. However, if the interval of the movement start time point of each movement control object unit is set to a sufficient constant value, the interval between the respective movement control objects can be maintained at a predetermined distance or more, and collision can be avoided. That is, the movement of the control object unit may be easily parallelized by performing the start of operation in each step (the operation of moving the distance of one control object unit is called one step) of each control object unit j calculated by [S→S′_UCMM_Navigation], [S′→M_LCMM_Navigation] after the completion of the operation in several steps ahead by the control object unit j′ which has started the movement one before. However, in (1) of [S′→M_LCMM_Navigation], when E is newly determined, and when “the control object position in contact with the Up in S′∩M at present time is added to the Up when newly contacting the control object in S′∩M which is not registered yet in the Up.” in (3) is executed, j does not start the operation until j′ reaches the target position (this is referred to “CASE_NO_TIME_CHANGE” hereinafter). The detail of this processing is as follows.

The detail of the processing is as follows.

[Linearization_S_M]

(1) The operation start time point of each movement control object is reset to 0. t_interval_S_S′=1, t_interval_S′_M=2 are set.

(2) i=2 is set. (3) is repeated until i=jmax/2 while incrementing i.

(3) Regarding the control object unit starting the movement at the i-th in [S→S′_UCMM_Navigation], when a time point when the control object unit starting the movement at the i−1-th completes the operation of the k-th step (k=1, 2, 3, k_last[i−1]) is defined as end_time[k][i−1], a value is adjusted so that the start time point of the operation of the k-th step of the control object unit starting the movement at the i-th does not become earlier than end_time[k+t_interval_S_S′][i−1] when k<=k_last[i−1]−t_interval_S_S′ is established. In the case of k>k_last[i−1]−t_interval_S_S, the start time point of the operation of the k-th step is adjusted to a value not earlier than end time[k_last[i−1][i−1]. This process is repeated from k=1 to k_last[i].

(4) I=2. (5) is repeated until I=jmax/2 while incrementing I.

(5) Regarding the control object unit starting the movement at the i-th in [S′→M_LCMM_Navigation], when a time point when the control object unit starting the movement at the i−1-th completes the operation of the k-th step (k=1, 2, 3, k_last[i−1]) is defined as end_time[k][i−1], a value is adjusted so that the start time point of the operation of the k-th step of the control object unit starting the movement at the i-th does not become earlier than end_time[k+t_interval_S′_M][i−1] when k<=k_last[i−1]−t_interval_S′_M is established. In the case of k>k_last[i−1]−t_interval_S′_M, the start time point of the operation of the k-th step is adjusted to a value not earlier than end_time[k_last[i−1][i−1]. When a CASE_NO_TIME_CHANGE occurs in the movement of the control object unit starting the movement at the i−1-th, the time point when the movement of the control object unit starting the movement at the i−1-th is completed is set as the movement start time point of the control object unit starting the movement at the i-th. This is repeated from k=1 to k_last[i].

[Position Replace Process at Intermediate Position M]

The position replacing process in M is performed as follows. The control object unit at the j-th position in the Hamiltonian cycle pH of M is numbered as j. The target position of each control object i in M is defined as target[i]. The control objects in j are defined as i1[j], i2[j], i3[j], and i4[j] (Rr[i1[j]]=Rr[i2[j]]=Rr[i3[j]]=Rr[i4[j]]=j).

The control object unit j first moves to four gap portions in the control object unit j+1 located at an adjacent position in pH. Thereafter, the control object unit j moves step by step to a gap in the control object unit located at the next position in pH, and when the target position of the control object in the control object unit j exists in the control object unit located at the adjacent position in pH, the control object unit j is replaced each time. This is repeated until the control object unit j returns to the original position.

[Permutation_M]

(1) j=1 is set.

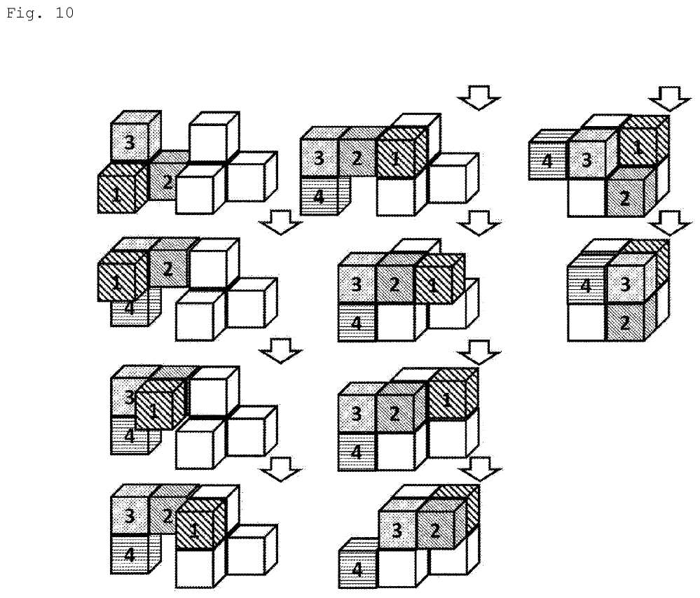

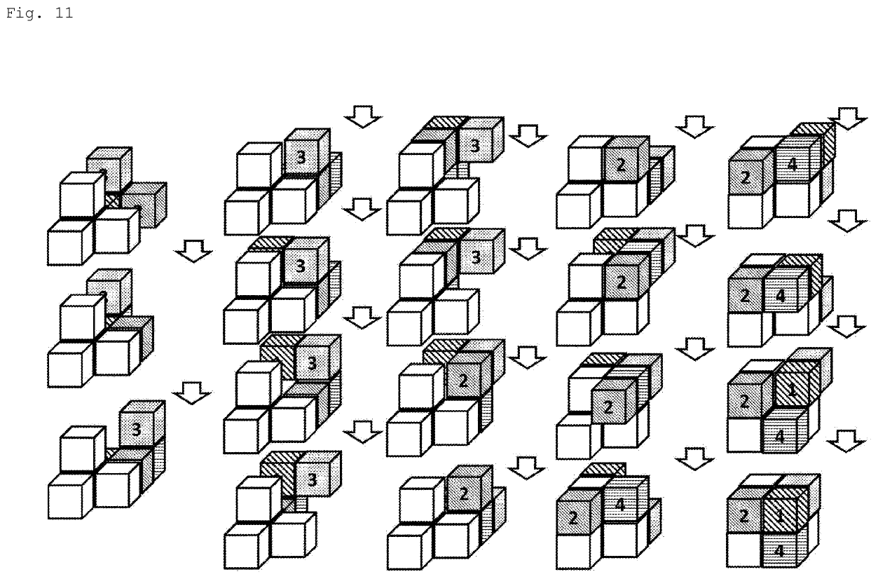

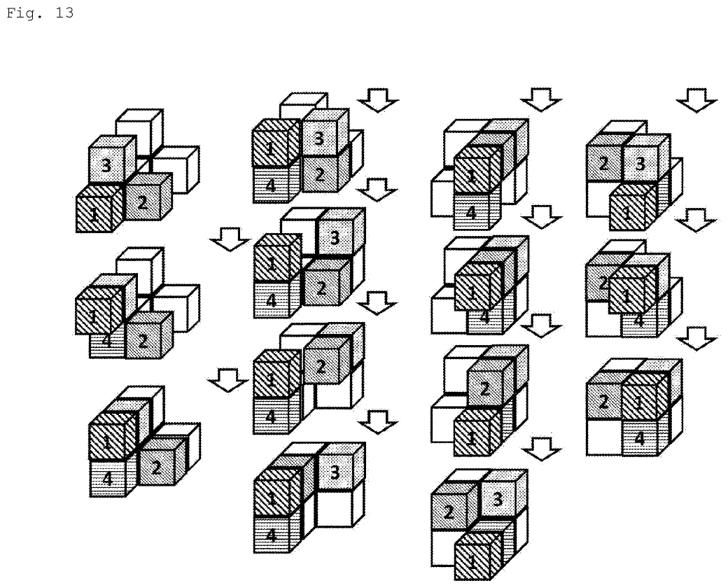

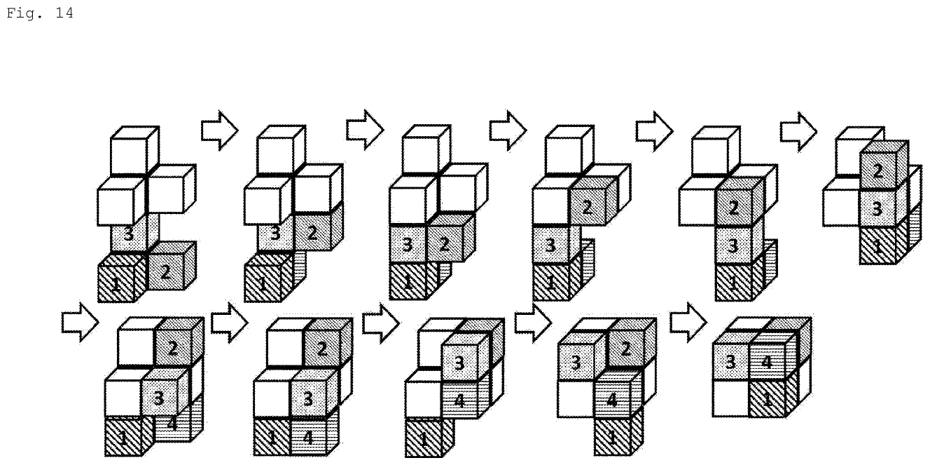

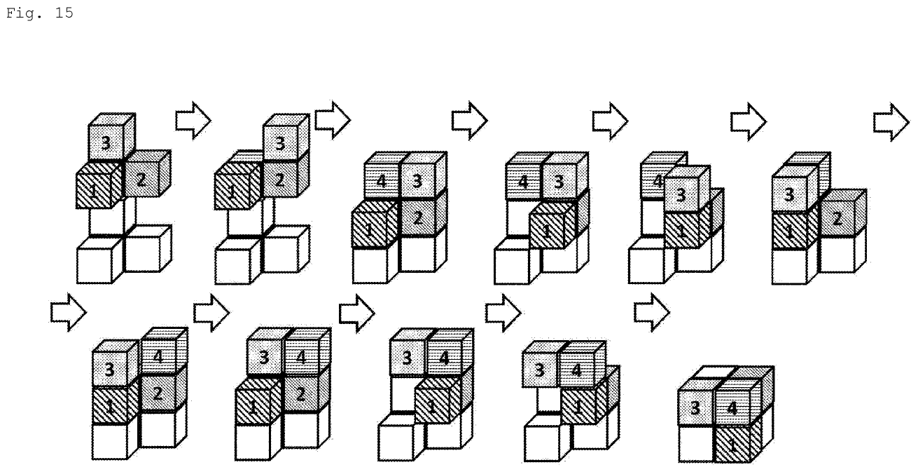

(2) k=1 is set. When j+k>jmax is satisfied, k−=jmax is set. The 4 mass control object unit j constituting M enters the 4 mass gap at the position of the control object unit j+k located next to j at the Hamiltonian cycle pH of M in the operation shown in FIGS. 10 to 15.

(3) When the control object is located at the position of j+k+1-th of pH and any target position target [iX[j]] of the control object iX[j] (X=1, 2, 3, 4) in j is present in the control object unit j+k+1, the control object iX[j] and the control object at the target position target [iX[j]] are replaced. The details of the replacement process are referred to [Exchange] described later. After the replacement, it is judged whether any target position target [iX[j]] of the control object iX[j] (X=1, 2, 3, 4) in j is present or not in the control object unit j+k+1, and the replacement processing is repeated until the target position target [iX[j]] is not present.

(4) When k=2 is satisfied (or k=2−jmax is satisfied when k−=jmax is executed in (2), (5)) and any target position target [iX[j]] of the control object iX[j] (X=1, 2, 3, 4) in j is present in the control object unit j+k−1, the control object iX[j] and the control object at the target position target [iX[j]] are replaced. The details of the replacement process are referred to [Exchange] described later. After the replacement, it is judged whether any target position target [iX[j]] of the control object iX[j] (X=1, 2, 3, 4) in j is present or not in the control object unit j+k+1, and the replacement processing is repeated until the target position target [iX[j]] is not present.

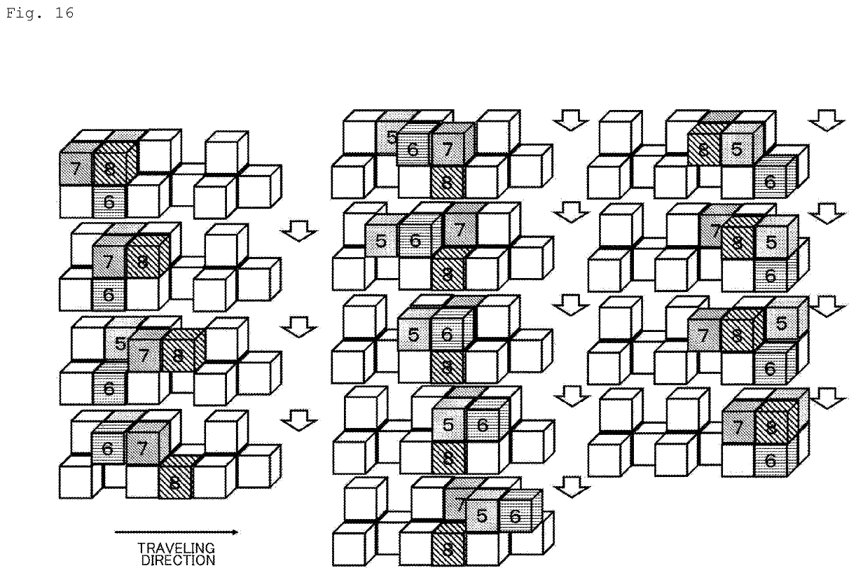

(5) When the control object is present at the j+k+1-th position of pH, the control object is moved to the control object unit j+k+1 by the operation shown in FIG. 16 to increment k, and when j+k>jmax is satisfied, k−=jmax is established. The process returns to (3). When there is no control object at the j+k+1-th position of pH (when the control object unit j returns to position before the original position by one after going around), in the case where the control object which has the target position in the control object unit j and is not located at the proper target position in j by returning to the state of LCMM of the control object unit j by reverse-operation from FIG. 10 to FIG. 15 as it is, all of such control objects in j are replaced in position in j by [Inner_Exchange]. Thereafter, the control object is moved to the j+k+1-th position of pH by the reverse-operation from FIG. 10 to FIG. 15 and the process is returned to (2) by incrementing j.

FIGS. 10 to 15 and 16 show operations taken when the control object unit j makes a round on the pH. When the control object unit j repeats two-step operation in the same direction in the operation of FIG. 16, the arrangement of the control object in j becomes the same as that before the two-step operation. Further, the arrangement of the control object in j of the operation after the one-step operation (leftward and rightward operation) of a=1 and a=3 is the same. The arrangement of the control object in j of the operation after the one-step operation (frontward and rearward operation) of a=2 and a=4 is the same. The arrangement of the control object in j of the operation after the one-step operation (upward and downward operation) of a=5 and a=6 is the same. Therefore, if the control object unit j returns to the original position by one revolution of the pH by using only the operation of FIG. 16, the arrangement of the control object in j is the same as that before the operation of rotating the pH.

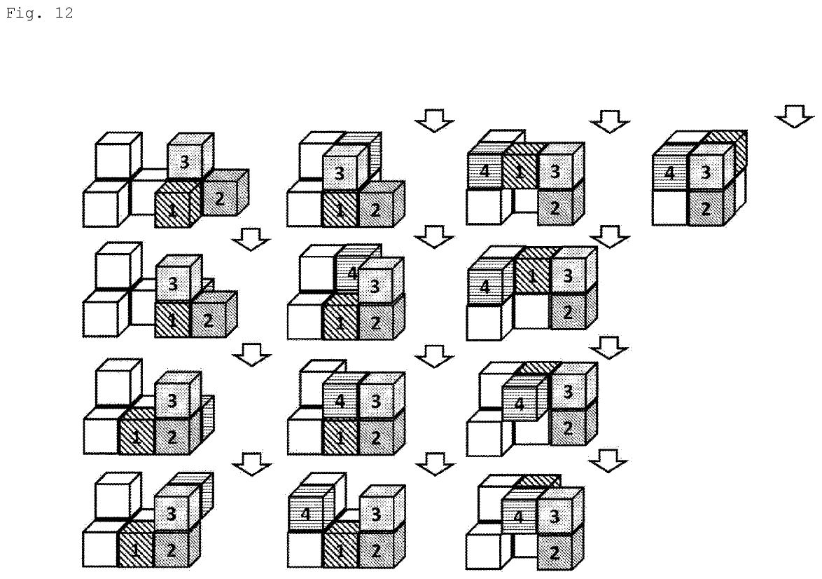

In the operations shown in FIGS. 10 to 15, for example, when the control object unit j moves in the direction of a=1 in the operation shown in FIG. 10 and when the control object j moves in the direction of a=3 in the operation shown in FIG. 12, the arrangement of the control object unit in j thereafter is the same. This is unchanged even when the set of values a is 2 and 4, and 5 and 6. That is, the control object j starts to move around within pH by the operations shown in FIGS. 10 to 15, repeats the operation shown in FIG. 16, and moves to a position one before returning to the original position, finally, in the case where the control object j returns to the original position in the reverse-operation of FIGS. 10 to 16, the arrangement of the control object in j is the same before and after the j is moved around at the pH.

In the [Exchange], the exchange operation changes depending on the positional relationship between the control object unit j and the control object unit j′ to be exchanged.

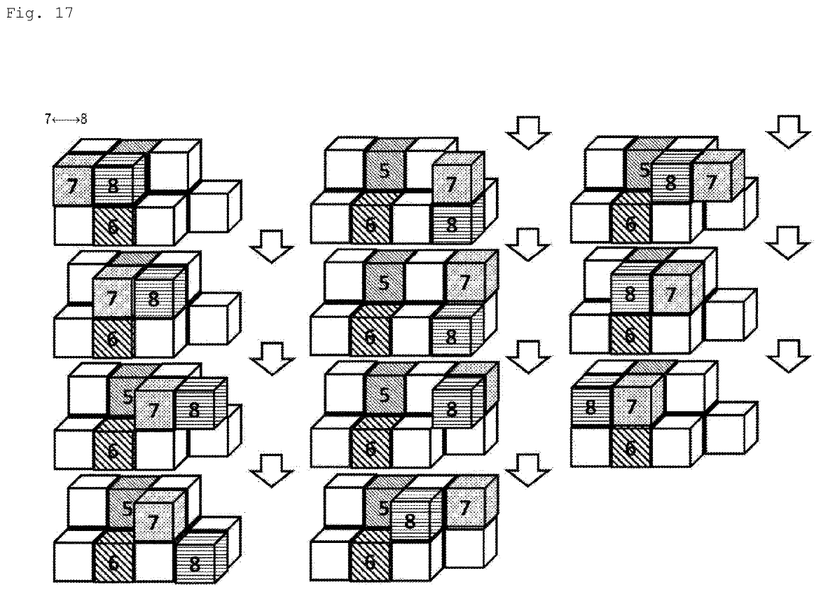

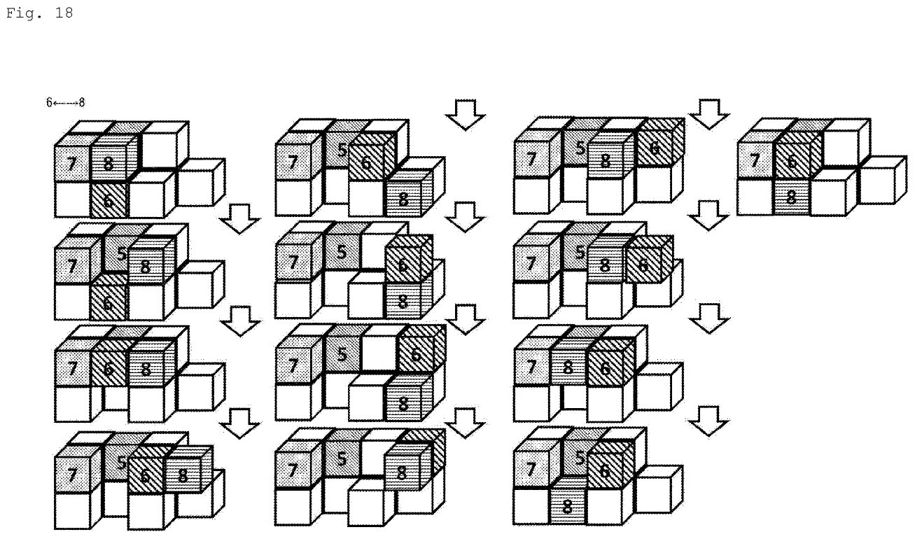

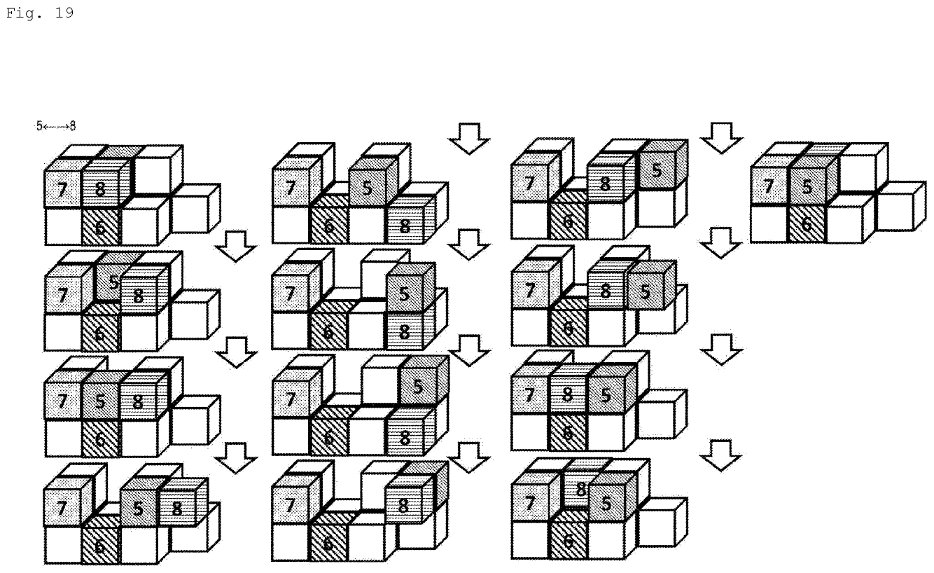

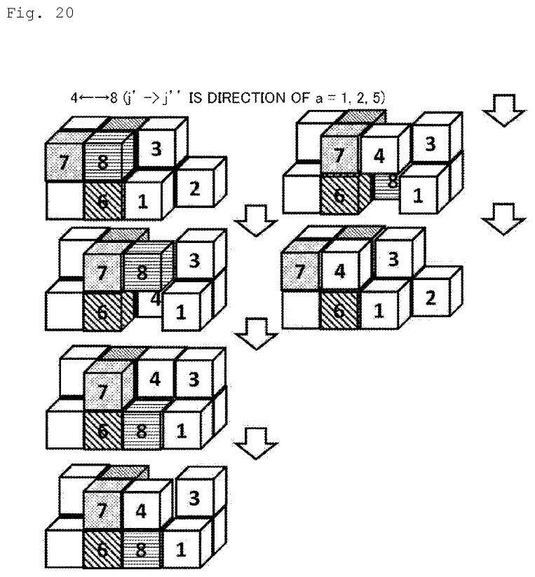

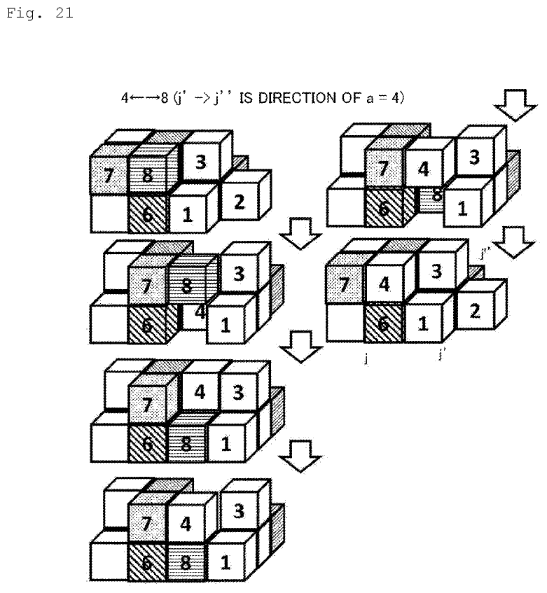

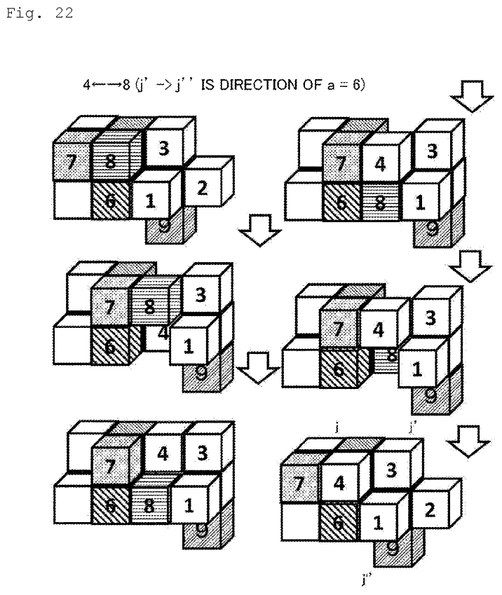

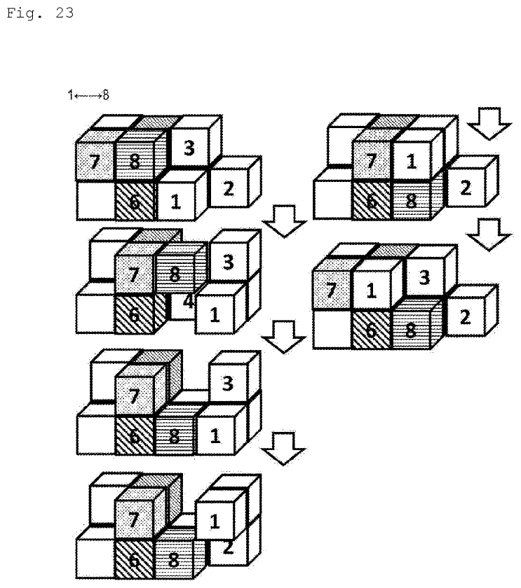

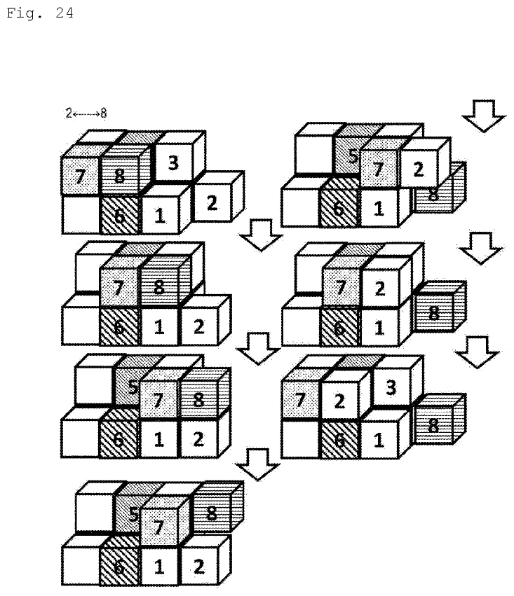

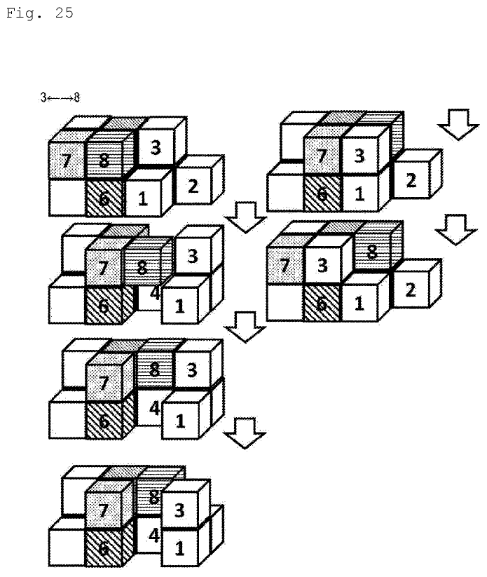

When the direction of j→j′ is a=1, 2 and 5, first, the control object i to be replaced in j is moved to the position 8 of FIGS. 17 to 19 in the control object unit j by the operations of FIGS. 17 to 19, and then the control object i′ at the position of target[i] in j′ and the control object i are replaced. In the case where the position of the control object i′ is 4 in FIGS. 20 to 25, the replacement operation differs depending on the direction in which the control object j″ at the next position on the pH of the control object j′ is located when viewed from j′ (the control object units are arranged in the order of j, j′, j″ in the pH). For example, when j→j′ is a=1 direction and j′→j″ is a=1, 2 and 5 direction, such a situation corresponds to FIG. 20, when j′→j″ is a=4 direction, such a situation corresponds to FIG. 21, and when j′→j″ is a=6 direction, such a situation corresponds to FIG. 22. In the case where the position of the control object i′ is 1, 2 and 3 in FIGS. 20 to 25, the replacement operation corresponds to FIG. 23 to 25.

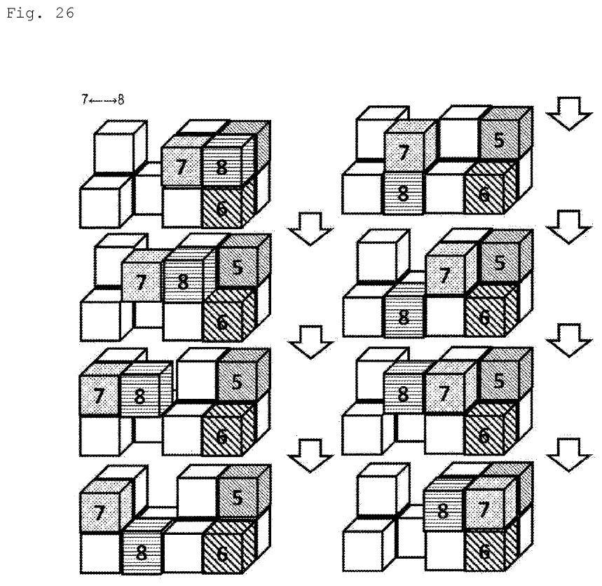

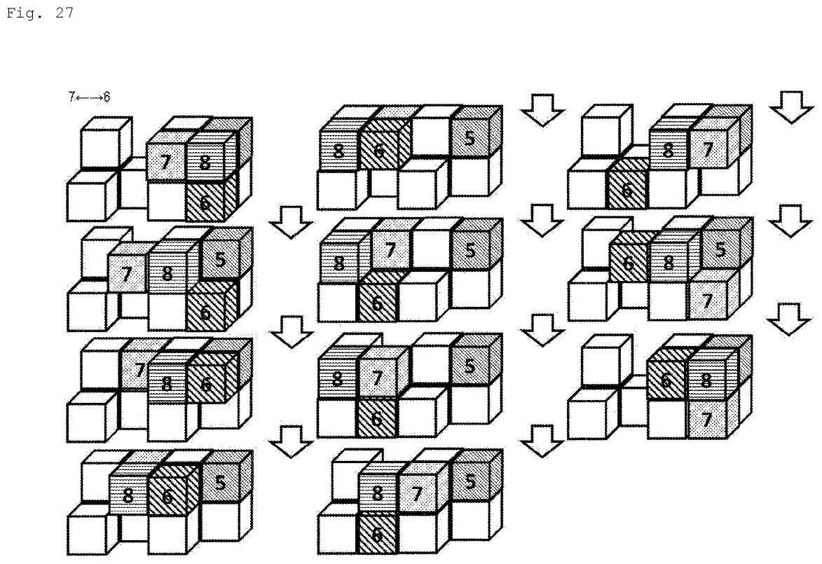

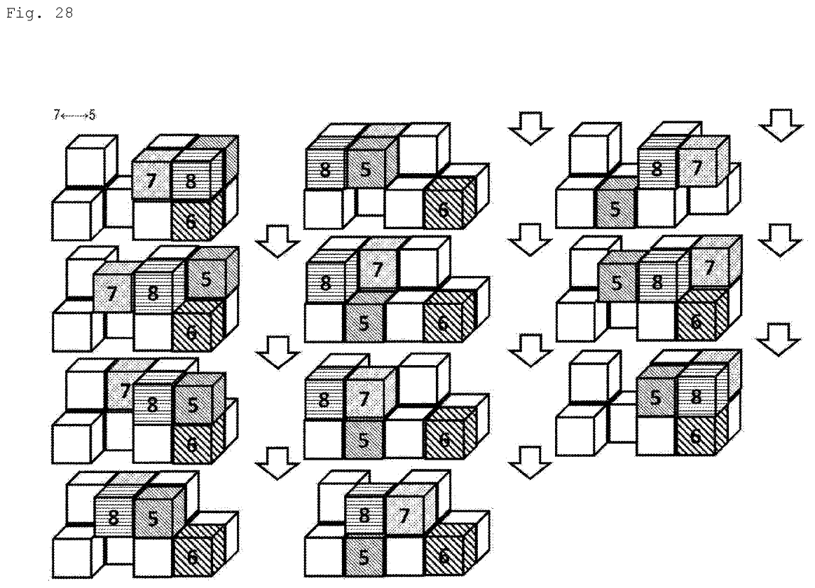

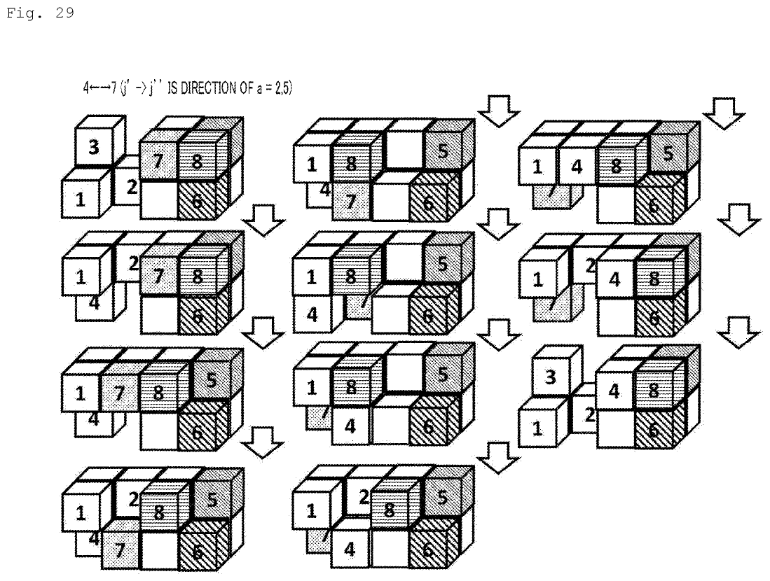

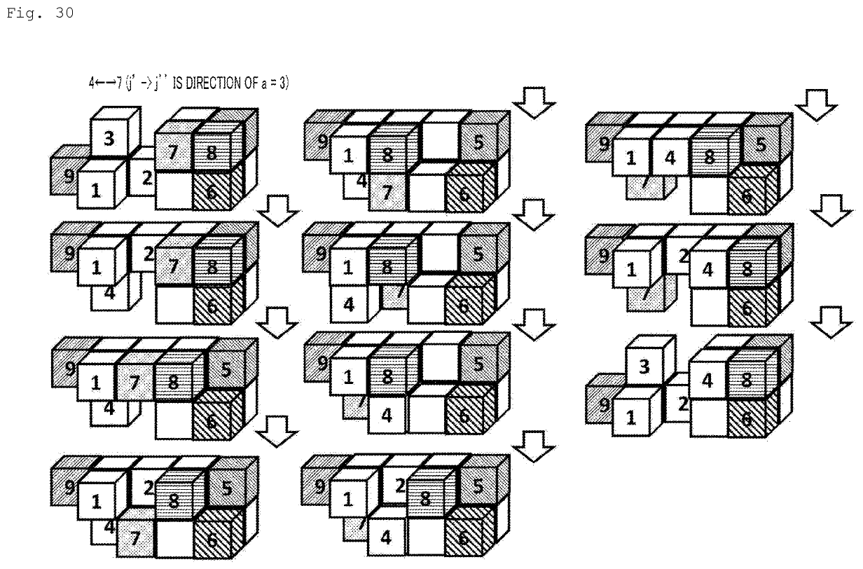

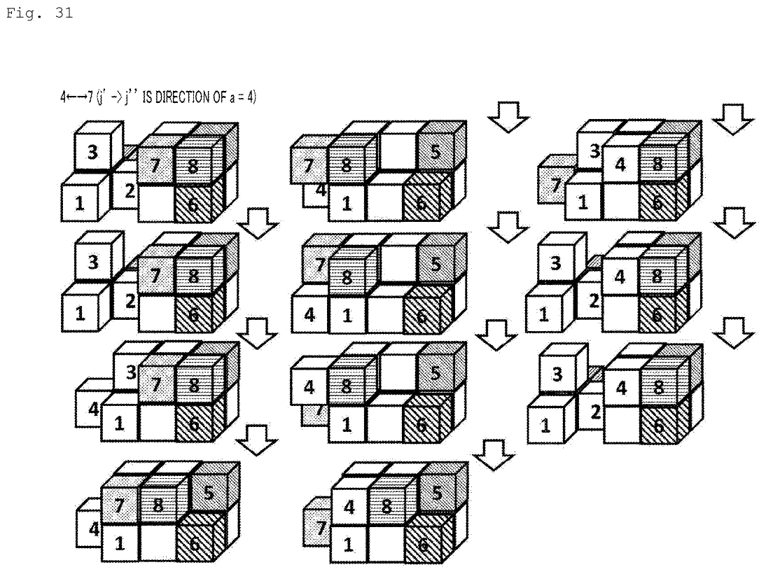

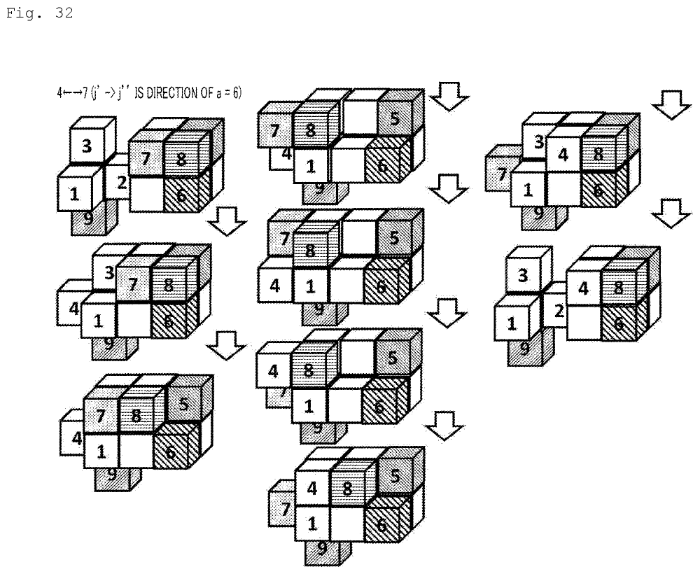

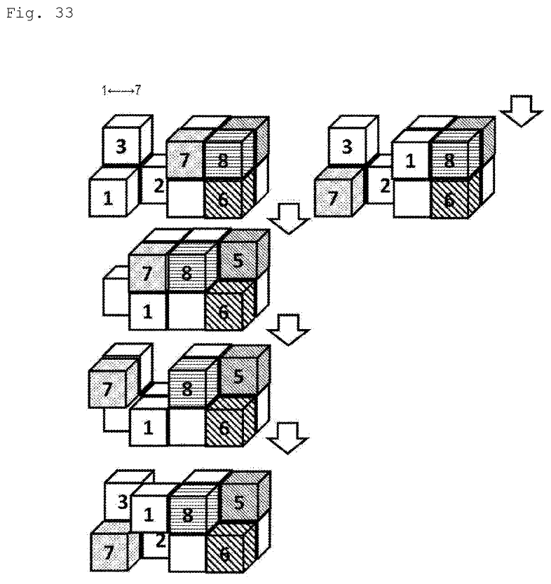

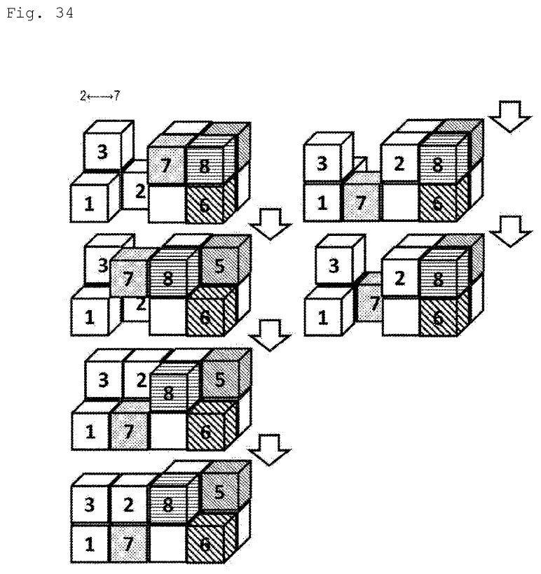

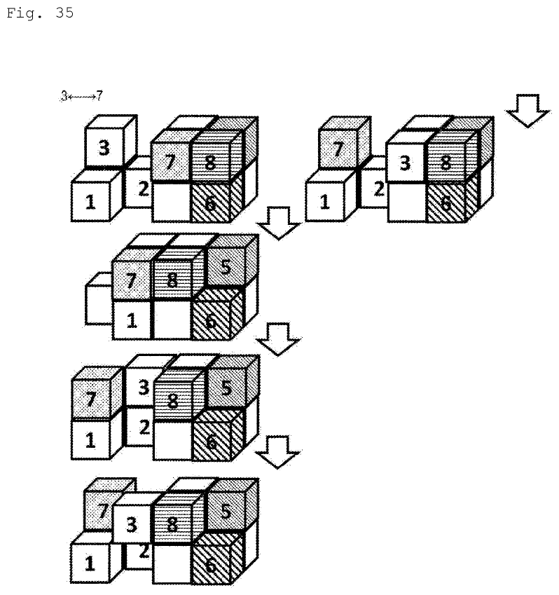

When the direction of j→j′ is a=3, 4 and 6, first, the control object i to be replaced in j is moved to the position 7 in FIGS. 26 to 28 in the control object unit j by the operations of FIGS. 26 to 28, and then the control object i′ at the position of target[i] in j and the control object i are replaced. In the case where the position of the control object i′ is 4 in FIGS. 29 to 35, the replacement operation differs depending on the direction in which the control object j″ at the next position on the pH of the control object j′ is located when viewed from j′. For example, when j→j′ is a=3 direction and j′→j″ is a=3 direction, such a situation corresponds to FIG. 30, when j′→j″ is a=4 direction, such a situation corresponds to FIG. 31, when j′→j″ is a=6 direction, such a situation corresponds to FIG. 32, and when j′→j″ is a=2 and 5 direction, such a situation corresponds to FIG. 29. When the position of the control object i′ is 1, 2, and 3 in FIGS. 29 to 35, the replacement operations correspond to FIGS. 33, 34, and 35, respectively.

The reason why the above-described case separation is necessary is that the control object at the position 4 shown in FIGS. 20 to 25 and FIGS. 29 to 35 has the only connecting surface in j′ of the connection with the control object unit at the positions adjacent to each other in the direction of a=3, 4 and 6. That is, the operation for maintaining the connection differs depending on the direction of the control object in j″ in the contact with the control object at the position 4. In addition, the reason why only the connection between j, j′ and j″ is required to be noted in the connection between the control objects is caused by the fact that M has the Hamiltonian cycle pH. That is, the connection of the whole M can be maintained if the connection between the adjacent control object units can be maintained within the cycle pH.

[Exchange (j, j, j″)]

(1) When there is one having the target position target[i] in the control object unit j′ among the control objects i in the control object unit j, the process proceeds to (2), when there is no one, the process is terminated.

(2) When the direction of j→j′ is a=1, 2 and 5, the process proceeds to (3) and when the direction of j→j′ is a=3, 4 and 6, the process proceeds to (6).

(3) When the position of the control object i in FIGS. 17 to 19 is other than 8, the control object i is moved to the position 8 by the operations shown in FIGS. 17 to 19.

(4) When the position of the target position target[i] within the control object unit j′ is 1, 2 and 3, the replacement is performed by the operations shown in FIGS. 23 to 25. When the position of the target position target[i] within the control object unit j′ is 4, the replacement operation is performed by the operations shown in FIGS. 20, 21 and 22 in accordance with the direction of j′→j″.

(5) the operation performed in (3) is repeatedly executed and the operation is terminated.

(6) When the position of the control object i in FIGS. 26 to 28 is other than 7, the control object i is moved to 7 by the operations shown in FIGS. 26 to 28.

(7) When the position of the target position target[i] within the control object unit j′ is 1, 2 and 3, the replacement is performed by the operations shown in FIGS. 33 to 35. When the position of the target position target[i] within the control object unit j′ is 4, the replacement operation is performed by the operations shown in FIGS. 29, 30, 31 and 32 in accordance with the direction of j′→j″.

(8) the operation performed in (3) is repeatedly executed and the operation is terminated.

The reason why [Inner_Exchange] is required is a treatment when the target position of the control object i′ newly entered into the control object j is within j as a result of the execution of the Exchange. When Exchange is only performed, i′ is located in j but it is not clear that i′ is located at the correct position in j. In this case, the role of [Inner_Exchange] is to move the i to the correct position in j. [Inner_Exchange] is provided in consideration of the case where the target position of the control object in the plurality of j is within j (that is, the case where the position replacement in j is necessary) at the stage before the position replacement process in M starts. For the processing of the [Inner_Exchange], the control object in each control object stores an internal arrangement of 1, 2, 3 and 4 in FIGS. 20 to 25, 29 to 35 before the respective control objects start to move around the pH. The variable is defined as Ori[i]. It is assumed that the information of Ori[i] is transferred from the object i to the object i′ at the time of executing the Exchange.

[Inner_Exchange(j, j′)]

(1) When there is a control object i having different positions in j indicated by Ori[i] and target[i] among control objects having target positions in the control object j, (2) and following process are executed for all of k=1, 2, 3 and 4.

(2) When the position indicated by target[i] is the position k in j and Ori[i]!=k is satisfied, it is assumed that the current position in j of i is pi (=5, 6, 7 and 8) in FIGS. 17 to 19, and when the current position in j of the control object ix to be Ori[ix]=k in j is pix (=5, 6, 7 and 8) in FIGS. 17 to 19,

(2-1) when the direction of j→j′ is a=1, 2 and 5,

(2-1-1) the control object at the position 8 shown in FIGS. 17 to 19 is replaced with the control object at the position pi.

(2-1-2) The control object at the position 8 shown in FIGS. 17 to 19 (the control object i is present now) is replaced with the control object at the position pix.

(2-1-3) The control object at the position 8 shown in FIGS. 17 to 19 (the control object ix is present now) is replaced with the control object at the position pi ((2-1-1) the control object at the position 8 before execution).

(2-1-4) pi and pix are updated.

(2-2) when the direction of j→j′ is a=3, 4 and 6, (2-2-1) the control object at the position 7 shown in FIGS. 26 to 28 is replaced with the control object at the position pi.

(2-2-2) the control object at the position 7 shown in FIGS. 26 to 28 (the control object i exists now) is replaced with the control object at the position pix.

(2-2-3) the control object at the position 7 shown in FIGS. 26 to 28 (the control object ix exists now) is replaced with the control object at the position pi ((2-2-1) the control object at the position 7 before execution).

(2-2-4) pi and pix are updated.

In the above-described position replacement process, the system in which the control object unit to be moved starts moving one by one, returns with moving around the pH, and complete the movement is adopted, so that the movement of the control object unit is not performed in parallel. However, similarly to the deformation process of S→M, when the interval of the movement start time of each movement control object unit is set to a sufficient constant value, the interval between the movement control objects can be maintained at a predetermined distance or more, and collision can be avoided. That is, the movement of the control object unit can be easily parallelized by setting the start of the operation in each step of the control object unit j (the operation of moving the distance corresponding to one control object unit are called one step.) after the completion of the operation in several steps ahead by the control object unit j′ which has started the movement one before. The reason is as follows.

[Linearization Permutation]

(1) The operation start time of each movement control object is reset to 0. t_interval_M=2 is set.

(2) i=2 is set. (3) is repeated until i=jmax is satisfied while incrementing i.

(3) Regarding the control object unit starting the movement at the i-th in [Permutation_M], a time point when the control object unit starting the movement at the i−1-th completes the operation of the k-th step (k=1, 2, 3, k_last[i−1]) is defined as end_time[k][i−1], a value is adjusted so that the start time point of the operation of the k-th step of the control object unit starting the movement at the i-th does not become earlier than end_time[k+t_interval_M][i−1] when k<=k_last[i−1]−t_interval_M is established. In the case of k>k_last[i−1]−t_interval_M, the start time of the operation of the k-th step is adjusted to a value not earlier than end_time[k_last[i−1]][i−1]. This is repeated from k=1 to k_last[i].

[Deformation Process of M→G]

The present deformation process is obtained by temporally reverse-reproducing the replaced S by G in [deformation process of S→M].

[Deformation Process of G→M]

(1) The virtual robot executes [G→G′_UCMM_Navigation].

(2) The virtual robot executes [G′→M_LCMM_Navigation] (G′ is a form formed by the control object generated as a result of (1).

(3) [Linearization_G_M] is executed.

[G→G′_UCMM_Navigation] (Process (1))

(1) One position of the control object in contact with a position in M which is not buried in the control object is selected from the control objects in M or G, and is defined as E. When there is no such E, the process is terminated.

(2) When the UCMM is present in E, the UCMM is moved to a gap position in M in contact with E, and is set to LCMM in M.

(3) The UCMM in G at the Manhattan distance closest to E is moved to the position E. The moving route is a route in which the Manhattan distance from E is reduced by one for each moving step.

(4) The UCMM which has reached the position E is moved to the target position D with defining a position which is not yet buried in the M and has the closest distance from the position E in the Manhattan distance in the M as the target position D.

A route tracing each position is generated so as to reduce the Manhattan distance one by one from D to E, and the UCMM is moved to D in the form of reverse-tracing the route from E to D. After the UCMM is moved to D, when “a gap in M which enters M-G via E as an inlet and reaches by tracing the control object unit already moved in M” still remains, the process returns to (3). If not, the process returns to (1).

[G′→M_LCMM_Navigation] (Process (2)

(1) All the positions in C[0] are registered in the Up (one of the G′∩M divided into a plurality of non-connected areas). One position of the control object in contact with a position in M which is not buried in the control object yet is selected from the control objects in the Up, and defined as E. If there is no such E, the process is terminated.

(2) The LCMM in the G′ outside the Up at the most distant Manhattan distance from E is selected as Tail and moved to the position E. The moving route is a route in which the Manhattan distance from E is reduced by one for each moving step.

(3) The LCMM has reached the position E is moved to the target position D with defining a position which is not yet buried in the M and is closest in the Manhattan distance in the M from E as the target position D. A route tracing each position is generated so as to reduce the Manhattan distance one by one from D to E, and the LCMM is moved to D in the form of reverse-tracing the route from E to D. After the LCMM is moved to D, the position of D is registered in the Up, and when the LCMM is newly brought into contact with the control object in the G′∩M which is not yet registered in the Up, the position of the control object coming in contact with the Up in the G′∩M at the present time is added to the Up. Thereafter, if “a gap in M to be reached by tracing the control object unit which enters the M-G′ via E as an inlet and has been moved into the M” still remains, the process returns to (2). If not, the process returns to (1).

[Linearization_G_M]

(1) The operation start time of each movement control object is reset to 0. t_interval_G_G′=1 and t_interval_G′_M=2 are set.

(2) i=2 is set. (3) is repeated until i=jmax/2 while incrementing i.

(3) Regarding the control object unit starting the movement at the i-th in [G→G′_UCMM_Navigation], a time point when the control object unit starting the movement at the i−1-th completes the operation of the k-th step (k=1, 2, 3, k_last[i−1]) is defined as end_time[k][i−1], a value is adjusted so that the start time point of the operation of the k-th step of the control object unit starting the movement at the i-th does not become earlier than end_time[k+t_interval_G_G′][i−1] when k<=k_last[i−1]−t_interval_G_G′ is established. In the case of k>k_last[i−1]−t_interval_G_G′, the start time of the operation of the k-th step is adjusted to a value not earlier than end_time[k_last[i−1]][i−1]. This is repeated from k=1 to k_last[i].

(4) i=2 is set. (5) is repeated until i=jmax/2 while incrementing i.

(5) Regarding the control object unit starting the movement at the i-th in [G′→M_LCMM_Navigation], a time point when the control object unit starting the movement at the i−1-th completes the operation of the k-th step (k=1, 2, 3, k_last[i−1]) is defined as end_time[k][i−1], a value is adjusted so that the start time point of the operation of the k-th step of the control object unit starting the movement at the i-th does not become earlier than end_time[k+t_interval_G′_M][i−1] when k<=k_last[i−1]−t_interval_G′_M is established. In the case of k>k_last[i−1]−t_interval_G′_M, the start time of the operation of the k-th step is adjusted to a value not earlier than end_time[k_last[i−1]][i−1]. When a CASE_NO_TIME_CHANGE occurs in the movement of the control object unit starting the movement at the i−1-th, the time point when the movement of the control object unit starting the movement at the i−1-th is completed is set as the movement start time point of the control object unit starting the movement at the i-th. This is repeated from k=1 to k_last[i].

[Whole Deformation Process]

By combining the processes described above, the whole heterogeneous deformation process is completed.

[All_Transformation]

(1) The control object is moved according to the operation history calculated in [Deformation Process of S→M]. This processing is performed by a first movement plan unit 1 and a first movement unit 2 which will be described later.

(2) [Deformation Process of G→M] is executed. This processing is performed by a second movement plan unit 3.

(3) The position of the control object passing through the operation history calculated in [Deformation Process of G→M] is used as the replacement destination position of each control object in [Permutation_M], and [Permutation_M] is executed. This processing is performed by an intermediate position replacement unit 4 which will be described later.

(4) The control object is moved according to the operation obtained by reversely reproducing the operation history calculated in [Deformation Process of G→M]. This processing is performed by a second movement unit 5 which will be described later.

### Embodiment

An embodiment of the present invention will be described in detail below. Further, components with the same function are denoted by the same reference numerals in the diagrams, and overlapping explanations are omitted accordingly. First, the embodiment of the control device and method will be described.

[Control Device and Method]

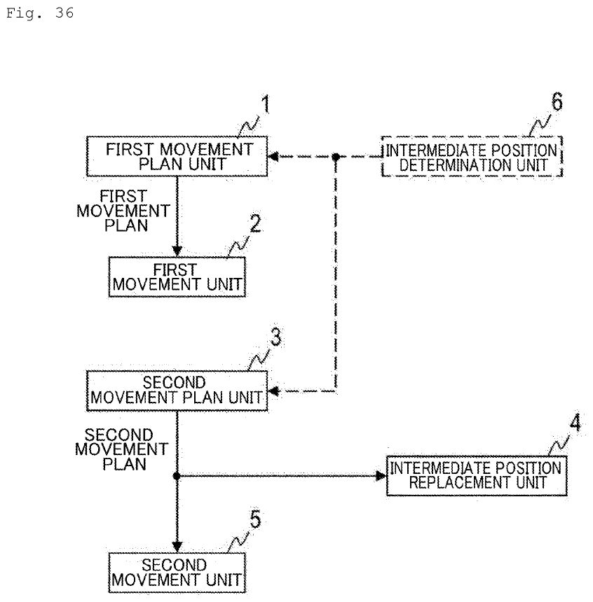

As shown in FIG. 36, the control device includes a first movement plan unit 1, a first movement unit 2, a second movement plan unit 3, an intermediate position replacement unit 4 and a second movement unit 5, for example.

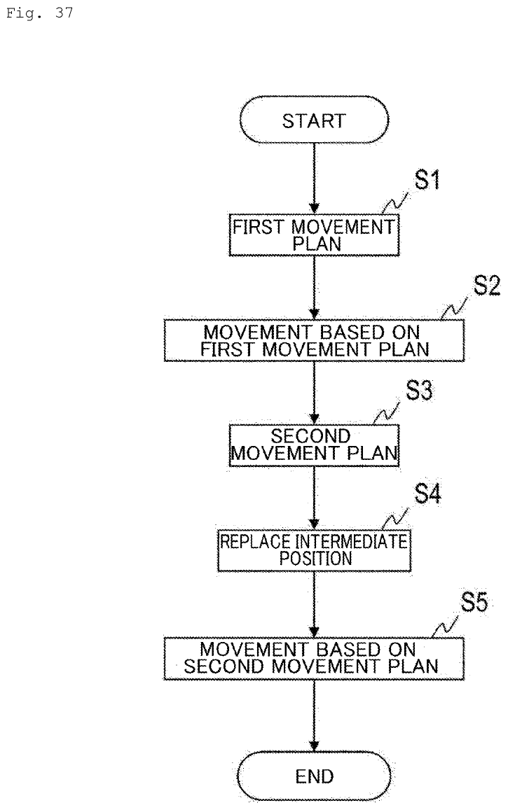

A control method is realized, for example, by causing each constituent unit of the control device to perform processing from step S1 to step S5 shown in FIG. 37 to be described below.

Each constituent unit of the control device will be described below.

<First Movement Plan Unit 1>

The first movement plan unit 1 creates a first movement plan for moving each control object at an initial position to an intermediate position in the control object units (step S1).

The created first movement plan is outputted to a first movement unit 2.

For example, the first movement plan unit 1 creates the first movement plan by performing the above-described [S→M Deformation Process].

More specifically, the first movement plan unit 1 creates the first movement plan by performing the above-described [S→S′_UCMM_Navigation] and [S→M_LCMM_Navigation].

That is, the first movement plan unit 1 creates a plan for moving each first type control object unit at the initial position S to M-S∩M and moving each second control object unit at S-S∩M to M-S∩M as the first movement plan.

If necessary, the first movement plan unit 1 performs the processing of the above described [Linearization_S_M] to re-create the created first movement plan so that the movement of the control object unit is performed in parallel. When the processing of [Linearization_S_M] is performed, the re-created first movement plan is outputted to the first movement unit 2.

In this embodiment, the processing is performed based on a predetermined intermediate position.

<First Movement Unit 2>

The first movement plan is inputted to the first movement unit 2.

The first movement unit 2 moves each control object at the initial position to an intermediate position in the control object units according to the first movement plan (step S2).

The first movement unit 2 moves the control object in the control object units according to the method described in [Deformation Process of S→M].

<Second Movement Plan Unit 3>

The second movement plan unit 3 creates a second movement plan for moving each control object assumed to be at the target position to the intermediate position in the control object units (step S3). The created second movement plan is outputted to the intermediate position replacement unit 4 and the second movement unit 5.

For example, the second movement plan unit 3 creates the second movement plan by performing the above-described [Deformation Process of G→M].

More specifically, the second movement plan unit 3 first creates the second movement plan by performing the above-described [G→G_UCMM_Navigation] and [G′→M_LCMM_Navigation].

That is, the second movement plan unit 3 moves each first type control object unit assumed to be at the target position G to M-G∩M and creates a plan for moving each second control object unit assumed to be at G-G∩M to M-G∩M as the second movement plan.

If necessary, the second movement plan unit 3 performs the processing of the above described [Linearization_G_M] to re-create the second movement plan so that the movement of the control object unit is performed in parallel. When the processing of [Linearization_G_M] is performed, the re-crested second movement plan is outputted to the intermediate position replacement unit 4 and the second movement unit 5.

<Intermediate Position Replacement Unit 4>

The second movement plan is inputted to the intermediate position replacement unit 4.

The intermediate position replacement unit 4 moves each control object moved by the first movement unit 2 to a movement destination of each control object determined by the second movement plan among the intermediate positions (step S4).

For example, the intermediate position replacement unit 4 performs the above-described [Position Replace Process at Intermediate Position M] processing.

That is, the intermediate position replacement unit 4 moves the control object unit j along the Hamiltonian cycle formed by the intermediate position, and when there is a movement destination determined by the second movement plan of the control object constituting the control object unit j among the control object units adjacent to the control object unit j, the intermediate position replacement unit 4 repeats the processing for replacing the control object with the control object at the movement destination to move each control object moved by the first movement unit to the movement destination of each control object determined by the second movement plan among the intermediate positions.

<Second Movement Unit 5>

The second movement plan is inputted to the second movement unit 5.

The second movement unit 5 moves each control object at the intermediate position to the target position in the control object units according to the plan obtained by temporally reversing the second movement plan (step S5).

The second movement unit 5 moves the control object in the control object units by the method described in [Deformation Process of S→M].

[Hamiltonian Cycle Expansion Device and Method]

The control device may include an intermediate position determination unit 6 shown by a broken line in FIG. 36. In this case, the intermediate position determination unit 6 determines the intermediate position by performing the above-described [M_Decision] processing. The determined intermediate position is outputted to the first movement plan unit 1 and the second movement plan unit 3.

The intermediate position determination unit 6 is realized by a Hamiltonian cycle expansion device described below.

The Hamiltonian cycle expansion device performs, for example, the processing described in [M_Decision] with reference to FIG. 6. Note that, in the [M_Decision], the Hamiltonian cycle constituted by the control object unit is expanded to be the intermediate position, but the Hamiltonian cycle expansion device may expand a general Hamiltonian cycle other than the Hamiltonian cycle constituted by the control object unit, further, the finally expanded Hamiltonian cycle may not be used as the intermediate position.

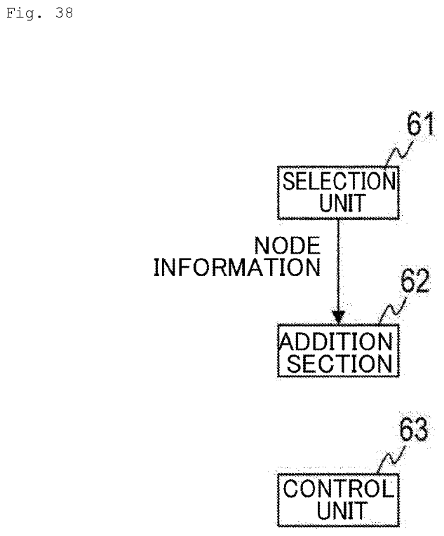

As shown in FIG. 38, for example, the Hamiltonian cycle expansion device includes a selection unit 61, an addition unit 62, and a control unit 63.

The selection unit 61 selects two nodes a, b which are located at positions respectively contacting two adjacent nodes k, k+1 on the Hamiltonian cycle and are not located on the Hamiltonian cycle (step S61). For example, the selection unit 61 selects a new node for two control object units a, b which are located at positions respectively in contact with two control object units k, k+1 corresponding to two adjacent nodes on the Hamiltonian cycle and are not located on the Hamiltonian cycle. Information regarding the selected nodes is outputted to the addition unit 62.

Note that the selection unit 61 selects two nodes a, b which are located at positions respectively contacting two adjacent nodes k, k+1 on the Hamiltonian cycle, are located on the Hamiltonian cycle, and further are located at the position with no obstacle.

The addition unit 62 adds the two nodes a, b selected by the selection unit 61 to the Hamiltonian cycle as new nodes, and adds an edge connecting the two nodes k, k+1 and the two nodes a, b to the Hamiltonian cycle as new edges (step S62).

For example, the selection unit 61 adds two control object units a, b which are not located on the Hamiltonian cycle to the Hamiltonian cycle as new nodes, and adds surfaces connecting the control object units k, k+1 and the control object units a, b to the Hamiltonian cycle as new edges.

The control unit 63 repeats the processing of the selection unit 61 and the addition unit 62 to expand the Hamiltonian cycle (step S63). For example, the selection unit 61 repeats the processing of the selection unit 61 and the addition unit 62 to expand the Hamiltonian cycle, and sets the position of the node of the expanded Hamiltonian cycle as the intermediate position.

Note that, in the first processing, the selection unit 61 and the addition unit 62 perform processing to the Hamiltonian cycle known beforehand to be the Hamiltonian cycle such as M₀. When N is defined as a positive integer of 2 or more, the selection unit 61 and the addition unit 62 perform processing to the Hamiltonian cycle to which the node and the edge are added in the N−1-th processing in the N-th processing.

In this way, the intermediate position determination unit 6 repeats processing for adding two control object units a, b which are respectively located at positions in contact with two control object units k, k+1 corresponding to two adjacent nodes on the Hamiltonian cycle and are not located on the Hamiltonian cycle as new nodes to the Hamiltonian cycle and adding surfaces respectively connecting the control object unit k, k+1 and the control object unit a, b as new edges to the Hamiltonian cycle, expands the Hamiltonian cycle, and set the position of the node of the expanded Hamiltonian cycle as the intermediate position.

### Modification Example

While an embodiment of the present invention has been described above, specific configurations are not limited to the embodiment, and it will be appreciated that the present invention also encompasses modifications or alterations without departing from the spirit and the scope of the invention.

The various types of processing described in the embodiments are not limited to being executed in a time series manner in the described order, and may be executed in parallel or individually in accordance with the processing capability of the device that executes the processing or as required.

In addition, data may be directly exchanged between the constituent units of the control device or may be exchanged via a storage unit (not shown).

[Program, Recording Medium]

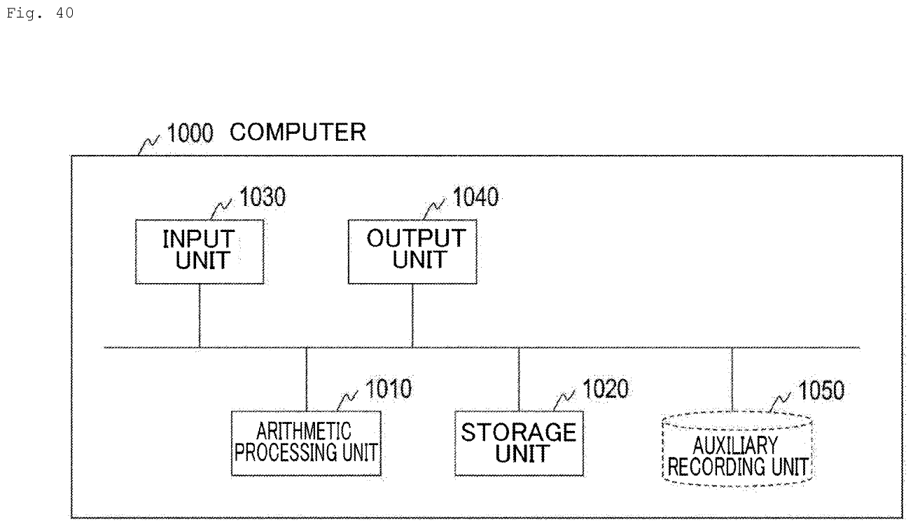

The processing of each unit of each device may be implemented by a computer, and in this case, the processing details of the functions that each device should have are described by a program. The various types of processing functions of each device are implemented on a computer, by causing this program to be loaded onto a storage unit 1020 of the computer 1000, and operating an arithmetic processing unit 1010, an input unit 1030, an output unit 1040, and the like shown in FIG. 40.

The program describing the processing contents can be recorded on a computer-readable recording medium. The computer-readable recording medium is, for example, a non-transitory recording medium, and specifically a magnetic recording device, an optical disc, and the like.

The program is distributed, for example, by sales, transfer, or lending of a portable recording medium such as a DVD or a CD-ROM on which the program is recorded. In addition, the distribution of the program may be performed by storing the program in advance in a storage device of a server computer and transferring the program from the server computer to another computer via a network.

A computer executing such a program is configured to, for example, first, temporarily store a program recorded on a portable recording medium or a program transferred from a server computer in an auxiliary recording unit 1050 which is its own non-temporary storage device. When executing the processing, the computer reads the program stored in the auxiliary recording unit 1050 which is its own non-temporary storage device into the storage unit 1020, and executes the processing according to the read program. As another embodiment of the program, the computer may directly read the program from the portable recording medium into the storage unit 1020 and execute processing according to the program. Each time the program is transferred from the server computer to the computer, the processing according to the received program may be executed sequentially. In addition, the processing may be executed by means of a so-called application service provider (ASP) service which does not transfer a program from the server computer to the computer and implements processing functions only by execution instructions and acquisition of the results. It is assumed that the program in this embodiment includes equivalent which is information to be provided for processing by an electronic computer and which is equivalent to a program (e.g., data that is not a direct command to the computer but has the property of defining the processing of the computer).

In addition, although the present device is configured by executing a predetermined program on the computer in this from, at least a part of the processing content may be implemented by hardware.

In addition, changes, alterations or modifications can be made as appropriate without departing from the gist of the present invention.

1. A control device, wherein
a control object unit includes a first type control object unit and a second type control object unit,
each of the first type control object unit and the second type control object unit is constituted by U (U is an integer of 4 or more) control objects,
an initial position and a target position are determined for each control object,
a structure constituted by the control object located at the initial position and the target position is constituted by a combined control object unit constituted by 2 U control objects by combining the first type control object unit and the second type control object unit,
a graph in which a control object unit in an intermediate position is defined as a node and a surface connecting two control object units in contact with each other is defined as an edge is defined as a Hamiltonian cycle, and
there is a space in which another control object unit can pass through and the positions are replaced between control object units in a peripheral on the control object unit located in the intermediate position, and
the control device comprising a processor configured to execute operations comprises:
creating a first movement plan, wherein the first movement plan includes moving each control object at the initial position to the intermediate position in control object units;
moving each control object at the initial position to the intermediate position in the control object units according to the first movement plan;
creating a second movement plan, wherein the second movement plan includes moving each control object assumed to be at the target position to the intermediate position in the control object units;
moving each control object to a movement destination of each control object determined by the second movement plan among the intermediate positions; and
moving each control object at the intermediate position to the target position in the control object units according to a plan obtained by temporally reversing the second movement plan.

2. The control device according to claim 1, the processor further configured to execute operations comprising:
repeating processing including:
adding two control object units a, b which are respectively located at positions in contact with two control object units k, k+1 corresponding to two adjacent nodes on the Hamiltonian cycle and are not located on the Hamiltonian cycle as new nodes to the Hamiltonian cycle, and
adding surfaces respectively connecting the control object unit k, k+1 and the control object unit a, b as new edges to the Hamiltonian cycle;
expanding the Hamiltonian cycle, and
setting the position of the node of the expanded Hamiltonian cycle as the intermediate position.

3. The control device according to claim 1, wherein
the moving each control object moved to the movement destination of each control object determined by the second movement plan among the intermediate position further comprises:
moving the control object unit j along the Hamiltonian cycle, and
when there is a movement destination determined by the second movement plan of the control object constituting the control object unit j among the control object units adjacent to the control object unit j, repeating the replacing the control object with the control object at the movement destination to move each control object moved according to the first movement plan to the movement destination of each control object determined by the second movement plan among the intermediate positions.

4. The control device according to claim 1, wherein
the initial position is defined as S,
the intermediate position is defined as M,
a common position between the initial position S and the intermediate position M is defined as S∩M,
a position obtained by excluding the common position S∩M between the initial position S and the intermediate position M from the intermediate position M is defined as M-S∩M,
a position obtained by excluding the common position S∩M between the initial position S and the intermediate position M from the initial position S is defined as S-S∩M,
the first movement plan includes moving each first type control object unit at the initial position S to M-S∩M and moving each second control object unit at S-S∩M to M-S∩M as the first movement plan,
the target position is defined as G,
the intermediate position is defined as M,
a common position between the target position G and the intermediate position M is defined as G∩M,
a position obtained by excluding the common position G∩M between the target position G and the intermediate position M from the intermediate position M is defined as M-G∩M,
a position obtained by excluding the common position G∩M between the target position G and the intermediate position M from the target position G is defined as G-G∩M, and
the second movement plan includes moving each second control object unit assumed to be at G-G∩M to M-G∩M as the second movement plan based on moving each first type control object unit assumed to be at the target position G to M-G∩M.

5. A control method, wherein
a control object unit includes a first type control object unit and a second type control object unit,
each of the first type control object unit and the second type control object unit is constituted by U (U is an integer of 4 or more) control objects,
an initial position and a target position are determined for each control object,
a structure constituted by the control object located at the initial position and the target position is constituted by a combined control object unit constituted by 2 U control objects by combining the first type control object unit and the second type control object unit,
a graph in which a control object unit in an intermediate position is defined as a node and a surface connecting two control object units in contact with each other is defined as an edge is defined as a Hamiltonian cycle,
there is a space in which another control object unit can pass through and the positions are replaced between control object units in a peripheral on the control object unit located in the intermediate position, and
the control method comprises:
creating a first movement plan for moving each control object at the initial position to the intermediate position in control object units;
moving each control object at the initial position to the intermediate position in the control object units according to the first movement plan;
creating a second movement plan for moving each control object assumed to be at the target position to the intermediate position in the control object units;
moving each control object moved according to the first movement plan to a movement destination of each control object determined by the second movement plan among the intermediate positions; and
moving each control object at the intermediate position to the target position in the control object units according to a plan obtained by temporally reversing the second movement plan.

6. A Hamiltonian cycle expansion device, comprising a processor configured to execute operations comprising:
selecting two nodes a, b which are respectively located at positions in contact with two adjacent nodes k, k+1 on a Hamiltonian cycle and are not located on the Hamiltonian cycle;
adding the selected two nodes a, b to the Hamiltonian cycle as new nodes;
adding edges connecting the two nodes k, k+1 and the two nodes a, b to the Hamiltonian cycle as new edges; and
expanding the Hamiltonian cycle by repeating the processing of the selecting two nodes a, b, the adding the selected two nodes a, b, and the adding edges.

7-8. (canceled)

9. The control device according to claim 2, wherein
the moving each control object moved to the movement destination of each control object determined by the second movement plan among the intermediate position further comprises:
moving the control object unit j along the Hamiltonian cycle, and
when there is a movement destination determined by the second movement plan of the control object constituting the control object unit j among the control object units adjacent to the control object unit j, repeating the replacing the control object with the control object at the movement destination to move each control object moved according to the first movement plan to the movement destination of each control object determined by the second movement plan among the intermediate positions.

10. The control device according to claim 2, wherein
the initial position is defined as S,
the intermediate position is defined as M,
a common position between the initial position S and the intermediate position M is defined as S∩M,
a position obtained by excluding the common position S∩M between the initial position S and the intermediate position M from the intermediate position M is defined as M-S∩M,
a position obtained by excluding the common position S∩M between the initial position S and the intermediate position M from the initial position S is defined as S-S∩M,
the first movement plan includes moving each first type control object unit at the initial position S to M-S∩M and moving each second control object unit at S-S∩M to M-S∩M as the first movement plan,
the target position is defined as G,
the intermediate position is defined as M,
a common position between the target position G and the intermediate position M is defined as G∩M,
a position obtained by excluding the common position G∩M between the target position G and the intermediate position M from the intermediate position M is defined as M-G∩M,
a position obtained by excluding the common position G∩M between the target position G and the intermediate position M from the target position G is defined as G-G∩M, and
the second movement plan includes unit includes moving each second control object unit assumed to be at G-G∩M to M-G∩M as the second movement plan based on moving each first type control object unit assumed to be at the target position G to M-G∩M.

11. The control device according to claim 3, wherein
the initial position is defined as S,
the intermediate position is defined as M,
a common position between the initial position S and the intermediate position M is defined as S∩M,
a position obtained by excluding the common position S∩M between the initial position S and the intermediate position M from the intermediate position M is defined as M-S∩M,
a position obtained by excluding the common position S∩M between the initial position S and the intermediate position M from the initial position S is defined as S-S∩M,
the first movement plan includes moving each first type control object unit at the initial position S to M-S∩M and moving each second control object unit at S-S∩M to M-S∩M as the first movement plan,
the target position is defined as G,
the intermediate position is defined as M,
a common position between the target position G and the intermediate position M is defined as G∩M,
a position obtained by excluding the common position G∩M between the target position G and the intermediate position M from the intermediate position M is defined as M-G∩M,
a position obtained by excluding the common position G∩M between the target position G and the intermediate position M from the target position G is defined as G-G∩M, and
the second movement plan includes moving each second control object unit assumed to be at G-G∩M to M-G∩M as the second movement plan based on moving each first type control object unit assumed to be at the target position G to M-G∩M.

12. The control method according to claim 5, further comprising:
repeating processing including:
adding two control object units a, b which are respectively located at positions in contact with two control object units k, k+1 corresponding to two adjacent nodes on the Hamiltonian cycle and are not located on the Hamiltonian cycle as new nodes to the Hamiltonian cycle; and
adding surfaces respectively connecting the control object unit k, k+1 and the control object unit a, b as new edges to the Hamiltonian cycle;
expanding the Hamiltonian cycle; and
setting the position of the node of the expanded Hamiltonian cycle as the intermediate position.

13. The control method according to claim 5, wherein
the moving each control object moved to the movement destination of each control object determined by the second movement plan among the intermediate position further comprises:
moving the control object unit j along the Hamiltonian cycle, and
when there is a movement destination determined by the second movement plan of the control object constituting the control object unit j among the control object units adjacent to the control object unit j, repeating the replacing the control object with the control object at the movement destination to move each control object moved according to the first movement plan to the movement destination of each control object determined by the second movement plan among the intermediate positions.

14. The control method according to claim 5, wherein
the initial position is defined as S,
the intermediate position is defined as M,
a common position between the initial position S and the intermediate position M is defined as S∩M,
a position obtained by excluding the common position S∩M between the initial position S and the intermediate position M from the intermediate position M is defined as M-S∩M,
a position obtained by excluding the common position S∩M between the initial position S and the intermediate position M from the initial position S is defined as S-S∩M,
the first movement plan includes moving each first type control object unit at the initial position S to M-S∩M and moving each second control object unit at S-S∩M to M-S∩M as the first movement plan,
the target position is defined as G,
the intermediate position is defined as M,
a common position between the target position G and the intermediate position M is defined as G∩M,
a position obtained by excluding the common position G∩M between the target position G and the intermediate position M from the intermediate position M is defined as M-G∩M,
a position obtained by excluding the common position G∩M between the target position G and the intermediate position M from the target position G is defined as G-G∩M, and
the second movement plan includes moving each second control object unit assumed to be at G-G∩M to M-G∩M as the second movement plan based on moving each first type control object unit assumed to be at the target position G to M-G∩M.

15. The control method according to claim 12, wherein
the moving each control object moved to the movement destination of each control object determined by the second movement plan among the intermediate position further comprises:
moving the control object unit j along the Hamiltonian cycle, and
when there is a movement destination determined by the second movement plan of the control object constituting the control object unit j among the control object units adjacent to the control object unit j, repeating the replacing the control object with the control object at the movement destination to move each control object moved according to the first movement plan to the movement destination of each control object determined by the second movement plan among the intermediate positions.

16. The control method according to claim 12, wherein
the initial position is defined as S,
the intermediate position is defined as M,
a common position between the initial position S and the intermediate position M is defined as S∩M,
a position obtained by excluding the common position S∩M between the initial position S and the intermediate position M from the intermediate position M is defined as M-S∩M,
a position obtained by excluding the common position S∩M between the initial position S and the intermediate position M from the initial position S is defined as S-S∩M,
the first movement plan includes moving each first type control object unit at the initial position S to M-S∩M and moving each second control object unit at S-S∩M to M-S∩M as the first movement plan,
the target position is defined as G,
the intermediate position is defined as M,
a common position between the target position G and the intermediate position M is defined as G∩M,
a position obtained by excluding the common position G∩M between the target position G and the intermediate position M from the intermediate position M is defined as M-G∩M,
a position obtained by excluding the common position G∩M between the target position G and the intermediate position M from the target position G is defined as G-G∩M, and
the second movement plan unit includes moving each second control object unit assumed to be at G-G∩M to M-G∩M as the second movement plan based on moving each first type control object unit assumed to be at the target position G to M-G∩M.

17. The control method according to claim 13, wherein
the initial position is defined as S,
the intermediate position is defined as M,
a common position between the initial position S and the intermediate position M is defined as S∩M,
a position obtained by excluding the common position S∩M between the initial position S and the intermediate position M from the intermediate position M is defined as M-S∩M,
a position obtained by excluding the common position S∩M between the initial position S and the intermediate position M from the initial position S is defined as S-S∩M,
the first movement plan includes moving each first type control object unit at the initial position S to M-S∩M and moving each second control object unit at S-S∩M to M-S∩M as the first movement plan,
the target position is defined as G,
the intermediate position is defined as M,
a common position between the target position G and the intermediate position M is defined as G∩M,
a position obtained by excluding the common position G∩M between the target position G and the intermediate position M from the intermediate position M is defined as M-G∩M,
a position obtained by excluding the common position G∩M between the target position G and the intermediate position M from the target position G is defined as G-G∩M, and
the second movement plan includes moving each second control object unit assumed to be at G-G∩M to M-G∩M as the second movement plan based on moving each first type control object unit assumed to be at the target position G to M-G∩M.
